(19) United States
(12) Patent Application Publication
(10) Pub. No.: US 2016/0227720 A1
(43) Pub. Date: Aug. 11, 2016

(54) Buoyant Devices, Buoyant Systems, and Methods of Placing Buoyant Devices Containing a Plant in a Liquid

(71) Applicant: Brian Villalon, Green Springs, OH (US)

(72) Inventor: Brian Villalon, Green Springs, OH (US)

(21) Appl. No.: 15/017,030

(22) Filed: Feb. 5, 2016

Related U.S. Application Data
(60) Provisional application No. 62/112,677, filed on Feb. 6, 2015.

(51) Int. Cl. A01G 31/02

(52) U.S. Cl. CPC A01G 31/02

(57) ABSTRACT

The technical description relates to buoyant devices, buoyant systems, and methods of placing buoyant devices containing a plant in a liquid. An example buoyant device includes an outer member having an upper surface, a lower surface, a side extending from the upper surface to the lower surface, and a passageway extending from the upper surface to the lower surface and an inner member having an upper surface, a lower surface, a side extending from the upper surface to the lower surface, and a passageway extending from the upper surface to the lower surface. The inner member is releasably attached to the outer member.

### RELATED APPLICATION

This application claims the benefit of U.S. Provisional Application No. 62/112,677 filed on Feb. 6, 2015. This related application is hereby incorporated into this disclosure in its entirety.

### FIELD

The disclosure relates to the field of aquatic devices, systems, and methods. More particularly, the disclosure relates to buoyant devices, buoyant systems, and methods of placing buoyant devices containing a plant in a liquid.

### BACKGROUND

The art includes several examples of buoyant devices, buoyant systems, and methods of placing buoyant devices containing a plant in a liquid. The home-gardening field, for example, includes floating gardens that house one or more plants. These floating gardens, though, often do not place a plant or another object in contact with a liquid and, instead, are designed to prevent the plant from contacting the liquid.

A need exists, therefore, for improved buoyant devices, buoyant systems, and methods of placing buoyant devices containing a plant in a liquid.

### BRIEF SUMMARY OF SELECTED EXAMPLES

Various example buoyant devices are described.

An example buoyant device configured to house a plant comprises an outer member having an upper surface, a lower surface, a side disposed between the upper surface and the lower surface, and a first passageway extending from the upper surface to the lower surface, the first passageway defining a first inner surface; and an inner member having an upper surface, a lower surface, a side extending from the upper surface to the lower surface, and a second passageway extending from the upper surface to the lower surface, the second passageway defining a second inner surface, the second inner surface configured to house said plant; wherein the side of the inner member is releasably attached to the first inner surface.

Another example buoyant device configured to house a plant comprises an outer member having a first portion, a second portion, a third portion, and a fourth portion, the first portion releasably attached to the second portion and the fourth portion, the second portion releasably attached to the first portion and the third portion, the third portion releasably attached to the second portion and the fourth portion, the first portion, second portion, third portion, and fourth portion cooperatively defining an upper surface, a lower surface, a side extending from the upper surface to the lower surface, and a first passageway, the upper surface being substantially circular, the lower surface being substantially circular, the first passageway extending from the upper surface to the lower surface, the first passageway defining a first inner surface; and an inner member having an upper surface, a lower surface, a side extending from the upper surface to the lower surface, and a second passageway, the second passageway extending from the upper surface to the lower surface, the second passageway defining a second inner surface, the second inner surface configured to house said plant; wherein the side of the inner member is releasably attached to the first inner surface.

Various example buoyant systems are also described.

An example buoyant system configured to house two or more plants comprises a first outer member having an upper surface, a lower surface, a side disposed between the upper surface and the lower surface, and a first passageway, the upper surface being hexagonal in shape, the lower surface being hexagonal in shape, the first passageway extending from the upper surface to the lower surface, the first passageway defining a first inner surface, the first inner surface comprising a first threaded portion; a first inner member having an upper surface, a lower surface, a side disposed between the upper surface and the lower surface, and a second passageway, the second passageway extending from the upper surface to the lower surface, the second passageway defining a second inner surface, the side comprising a second threaded portion releasably attached to the first threaded portion; a second outer member having an upper surface, a lower surface, a side disposed between the upper surface and the lower surface, and a third passageway, the upper surface being hexagonal in shape, the lower surface being hexagonal in shape, the third passageway extending from the upper surface to the lower surface, the third passageway defining a third inner surface, the third inner surface comprising a third threaded portion; and a second inner member having an upper surface, a lower surface, a side disposed between the upper surface and the lower surface, and a fourth passageway, the fourth passageway extending from the upper surface to the lower surface, the fourth passageway defining a fourth inner surface, the side comprising a fourth threaded portion releasably attached to the third threaded portion; wherein the second inner surface is in contact with one of said two or more plants; wherein the fourth inner surface is in contact with one of said two or more plants; and wherein the side of the first outer member is in contact with the side of the second outer member.

Additional understanding of the claimed devices, systems, and methods can be obtained by reviewing the detailed description of selected examples, below, with reference to the appended drawings.

### DESCRIPTION OF FIGURES

FIG. 1 is an exploded view of a first example buoyant device.

FIG. 2 is a top view of the first example buoyant device.

FIG. 3 is a side view of the first example buoyant device.

FIG. 4 is a cross-sectional view of the buoyant device illustrated in FIG. 3 taken along line 4-4.

FIG. 5 is a side view of the first example buoyant device with an associated plant.

FIG. 6 is a cross-sectional view of the buoyant device and plant illustrated in FIG. 5 taken along line 6-6.

FIG. 7 is a perspective view of a second example buoyant device.

FIG. 8 is a side view of the buoyant device illustrated in FIG. 7.

FIG. 9 is an exploded view of a third example buoyant device.

FIG. 10 is a top view of the third example buoyant device.

FIG. 11 is a top view of a first example system that includes multiple buoyant devices.

FIG. 12 is a top view of the first example system. The outer members of the devices of the system are illustrated without their corresponding inner members.

FIG. 13 is a magnified side view of Area I of the first example system illustrated in FIG. 12.

FIG. 14 is a top view of the first example system with associated cages.

FIG. 15 is a side view of the system illustrated in FIG. 14.

FIG. 16 is a top view of a fourth example buoyant device.

FIG. 17 is a side view of the buoyant device illustrated in FIG. 16.

FIG. 17A is a side view of a fifth example buoyant device.

FIG. 17B is a perspective view of the buoyant device illustrated in FIG. 17A.

FIG. 17C is a cross-sectional view of the buoyant device illustrated in FIG. 17B, taken along line 17C-17C and illustrated without a grow medium and plant.

FIG. 17D is a cross-sectional view of the buoyant device illustrated in FIG. 17B, taken along line 17D-17D and illustrated without a grow medium and plant.

FIG. 17E is an aerial view of a system of buoyant devices.

FIG. 18 is a sectional view of an example inner member.

FIG. 18A is a sectional view of an alternative inner member.

FIG. 19 is a flowchart representation of an example method of placing buoyant devices containing a plant in a liquid.

### DETAILED DESCRIPTION OF SELECTED EXAMPLES

The following detailed description and the appended drawings describe and illustrate various example buoyant devices configured to house a plant. The description and illustration of these examples are provided to enable one skilled in the art to make and use the buoyant devices configured to house a plant. They are not intended to limit the scope of the claims in any manner.

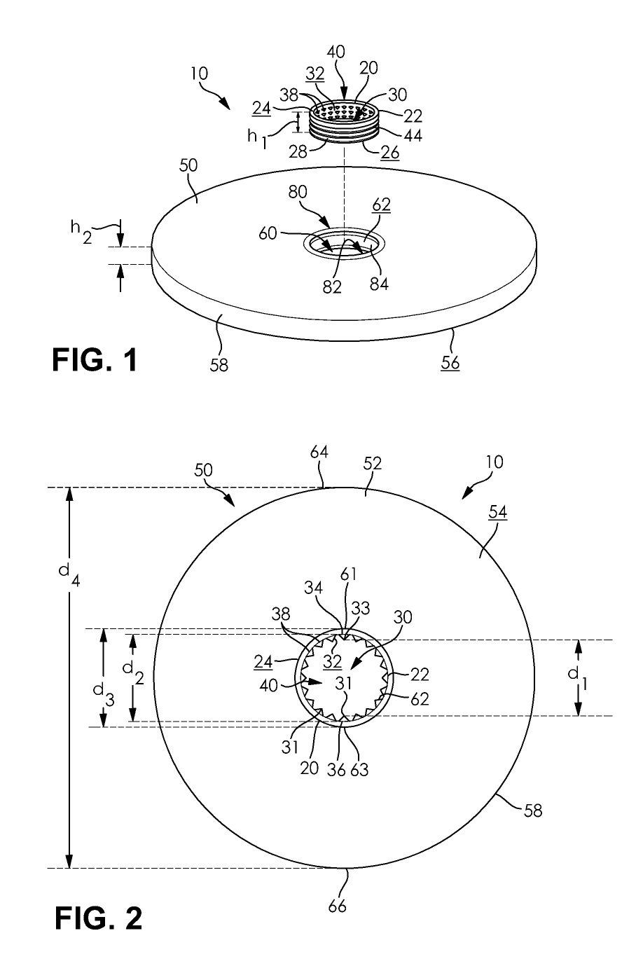

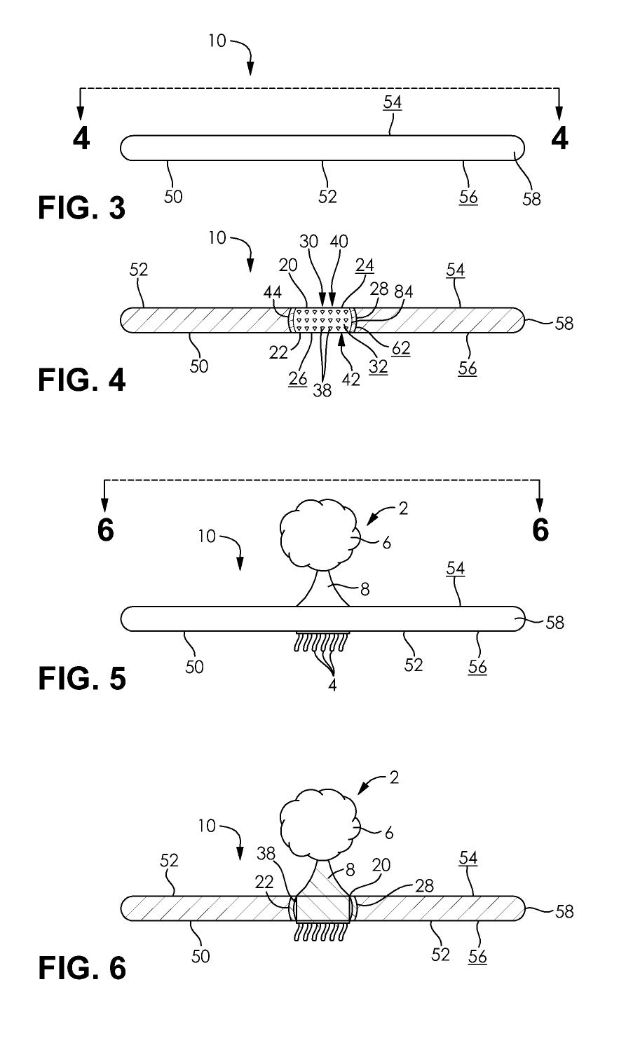

Each of FIGS. 1, 2, 3, and 4 illustrates a first example buoyant device 10 configured to house a plant (not illustrated in FIGS. 1 through 4). The buoyant device 10 includes an inner member 20 and an outer member 50. The inner member 20 is releasably attached to the outer member 50.

The inner member 20 has a main body 22 having an upper surface 24, a lower surface 26 substantially opposite the upper surface 24, a first side 28 extending from the upper surface 24 to the lower surface 26, a first passageway 30, and an inner surface 32.

In the illustrated embodiment, the main body 22 of the inner member 20 is substantially disc-shaped. As such, the upper surface 24 is substantially circular and the lower surface 26 is substantially circular. Each of the main body 22, the upper surface 24, and the lower surface 26 may have any suitable shape, however. A skilled artisan will be able to select suitable shapes for the main body, the upper surface, and the lower surface according to a particular example based on various considerations, including the size and shape of the outer member, the plant that will be housed by the inner member, and the liquid into which the buoyant device is placed. In alternative embodiments, the main body may be bucket-shaped, egg-shaped, pyramid-shaped, cube-shaped, or have any other shape. In other embodiments, the upper surface may be square, rectangular, trapezoidal, triangular, ovoid, elliptical, or any other shape. In different embodiments, the lower surface may be square, rectangular, trapezoidal, triangular, ovoid, elliptical, or any other shape. In addition, the lower surface may be shaped the same as, substantially the same as, or differently than the upper surface.

The first side 28 defines a first height h₁ extending from the upper surface 24 of the main body 22 to the lower surface 26 of the main body 22. The first side 28 also defines a first threaded portion 44. The first threaded portion 44 extends along the entire first height h₁ of the first side 27 and is configured to mate with the second threaded portion (described below) of the outer member 50. The first threaded portion 44 is integrally formed with the first side 28 of the main body 22 in the illustrated embodiment. The first height h₁ may have any suitable measurement and the first threaded portion 44 may have any configuration, however. A skilled artisan will be able to select a suitable first height and a suitable configuration for the first threaded portion according to a particular example based on various considerations, including the size and shape of the outer member, the plant that will be housed by the inner member, and the liquid into which the buoyant device is placed. In an alternative embodiment, the first threaded portion may extend from the upper surface toward the lower surface along about 10 percent to about 70 percent of the height of the first side. In a different embodiment, the first threaded portion may extend from the upper surface toward the lower surface along about 25 percent to about 55 percent of the height of the first side. In another embodiment, the first threaded portion may extend from the upper surface toward the lower surface along about 35 percent to about 45 percent of the height of the first side. Additionally, in alternative embodiments, rather than being integrally formed with the first side, the first threaded portion may be attached to the first side via an adhesive, a mechanical structure, welding, or any other suitable attachment mechanism.

The upper surface 24 and the lower surface 26 cooperatively define a first passageway 30 that extends from the upper surface 24 to the lower surface 26 about the central longitudinal axis (not illustrated in the Figures) of the inner member 20. The inner surface 32 is defined by the first passageway 30 and extends from the upper surface 24 to the lower surface 26. The inner surface 32 and upper surface 24, therefore, cooperatively define an upper opening 40 and the inner surface 32 and the lower surface 26 cooperatively define a lower opening 42. Each of the upper and lower openings 40, 42 is circular in the illustrated embodiment. The upper and lower openings 40, 42 may have any shape, however. A skilled artisan will be able to select whether to extend the first passageway from the upper surface to the lower surface and suitable shapes for the upper and lower openings according to a particular example based on various considerations, including the size and shape of the outer member, the plant that will be housed by the inner member, and the liquid into which the buoyant device is placed. Though the first passageway 30 extends from the upper opening 40 to the lower opening 42 and has the same height (not illustrated in the Figures) as the first height h₁ of the first side 28 in this embodiment, in an alternative embodiment the first passageway may extend from the upper opening towards the lower surface, but not fully extend to the lower surface. In such an embodiment, the lower surface does not define a lower opening; instead, the first passageway has an upper opening opposite a floor. In alternative embodiments, the first passageway may define a height that is equal to, about equal to, or less than the first height of the first side. In other embodiments, the upper opening may be square, rectangular, trapezoidal, triangular, ovoid, elliptical, or any other shape. In different embodiments, the lower opening may be square, rectangular, trapezoidal, triangular, ovoid, elliptical, or any other shape. In addition, the lower opening may be shaped the same as, substantially the same as, or differently than the upper opening.

As best illustrated in FIG. 2, the inner surface 32 defines a first diameter d₁ extending through the central longitudinal axis from a first point 31 disposed where the upper surface 24 is adjacent the inner surface 32 to a second point 33 where the upper surface 24 is adjacent the inner surface 32. The first diameter d₁ is constant along the entire first passageway 30 from the upper surface 24 to the lower surface 26. The first diameter d₁ may have any suitable measurement, however. A skilled artisan will be able to select a suitable first diameter according to a particular example based on various considerations, including the size and shape of the outer member, the plant that will be housed by the inner member, and the liquid into which the buoyant device is placed. In an alternative embodiment, the first diameter may taper from the upper surface to the lower surface. In a different embodiment, the first diameter may taper from the lower surface to the upper surface. Alternatively, the first diameter may first taper, and then expand from the upper surface to the lower surface.

The upper surface 24 defines a second diameter d₂ extending through the central longitudinal axis (not illustrated in the Figures) from a third point 34 disposed where the upper surface 24 is adjacent the first side 28 to a fourth point 36 where the upper surface 24 is adjacent the first side 28. The second diameter d₂ is constant from the upper surface 24 to the lower surface 26. The second diameter d₂ is greater than the first diameter d₁ in the illustrated embodiment. The second diameter d₂ may have any suitable measurement, however. A skilled artisan will be able to select a suitable second diameter according to a particular example based on various considerations, including the size and shape of the outer member, the plant that will be housed by the inner member, and the liquid into which the buoyant device is placed. In an alternative embodiment, the second diameter may taper from the upper surface to the lower surface. In a different embodiment, the second diameter may taper from the lower surface to the upper surface. Alternatively, the second diameter may first taper, and then expand from the upper surface to the lower surface. Additionally, the first diameter may be between about 50 percent and about 99 percent as great as the second diameter in other embodiments. In alternative embodiments, the first diameter may be between about 60 percent and about 90 percent as great as the second diameter. In different embodiments, the first diameter may be between about 70 percent and about 80 percent as great as the second diameter.

The inner member 20 also includes a plurality of teeth 38 disposed on the inner surface 32. Each of the plurality of teeth 38 is triangular in shape and is designed to contact and grasp a plant (described below) disposed within the first passageway 30 of the inner member 20. In the illustrated embodiment, the plurality of teeth 38 is attached to the inner surface 38 via an adhesive. The inner member 20 may have any suitable mechanism for housing the plant within the first passageway 30, however. A skilled artisan will be able to select an appropriate mechanism for contacting and grasping a plant based on various considerations, including the size and shape of the outer member, the plant that will be housed by the inner member, and the liquid into which the buoyant device is placed. In another embodiment, the inner surface may be coated with an adhesive that enables the inner surface to house the plant within the first passageway upon contact between the inner surface and the plant. In an alternative embodiment, the inner surface may comprise a platform extending from the inner surface across a portion of the first passageway on which the plant may be placed. In a different embodiment, the first passageway may be packed with a grow medium in which the plant is disposed; the grow medium may rest on a platform or be attached to the inner surface via an adhesive. Furthermore, the plurality of teeth may be integrally formed with the inner surface, rather than attached to the inner surface via an adhesive. The first passageway, and, thus, the inner surface, may also taper to such a degree from the upper surface to the lower surface that the inner member may need no mechanism for housing the plant apart from the shape of the inner surface itself.

The outer member 50 has a main body 52 having an upper surface 54, a lower surface 56 substantially opposite the upper surface 54, a second side 58 extending from the upper surface 54 to the lower surface 56, a second passageway 60, and an inner surface 62.

In the illustrated embodiment, the main body 52 of the outer member 50 is substantially disc-shaped. As such, the upper surface 54 is substantially circular and the lower surface 56 is substantially circular. Each of the main body 52, the upper surface 54, and the lower surface 56 may have any suitable shape, however. A skilled artisan will be able to select suitable shapes for the main body, the upper surface, and the lower surface according to a particular example based on various considerations, including the size and shape of the inner member, the plant that will be housed by the inner member, and the liquid into which the buoyant device is placed. In alternative embodiments, the main body may be bucket-shaped, egg-shaped, pyramid-shaped, cube-shaped, or have any other shape. In other embodiments, the upper surface may be square, rectangular, trapezoidal, triangular, ovoid, elliptical, or any other shape. In different embodiments, the lower surface may be square, rectangular, trapezoidal, triangular, ovoid, elliptical, or any other shape. In addition, the lower surface may be shaped the same as, substantially the same as, or differently than the upper surface.

The second side 58 defines a second height h₂ extending from the upper surface 54 of the main body 52 to the lower surface 56 of the main body 52. In the illustrated embodiment, the second height h₂ is about equal to the first height h₁ of the first side 28. The second height h₂ may have any measurement relative to the first height h₁, however. A skilled artisan will be able to select a suitable second height according to a particular example based on various considerations, including the size and shape of the inner member, the plant that will be housed by the inner member, and the liquid into which the buoyant device is placed. In alternative embodiments, the second height may be greater than, equal to, about equal to, or less than the first height.

The upper surface 54 and the lower surface 56 cooperatively define a second passageway 60 that extends from the upper surface 54 to the lower surface 56 about the central longitudinal axis (not illustrated in the Figures) of the outer member 50. An inner surface 62 is defined by the second passageway 60 and extends from the upper surface 54 to the lower surface 56. The inner surface 62 and the upper surface 54, thus, cooperatively define an upper opening 80 and the lower surface 56 cooperatively define a lower opening 82. Each of the upper and lower openings 80, 82 is circular in the illustrated embodiment. The upper and lower openings 80, 82 may have any shape, however. A skilled artisan will be able to select whether to extend the second passageway from the upper opening to the lower opening and suitable shapes for the upper and lower openings according to a particular example based on various considerations, including the size and shape of the inner member, the plant that will be housed by the inner member, and the liquid into which the buoyant device is placed. Though the second passageway 60 extends from the upper opening 80 to the lower opening 82 and has the same height (not illustrated in the Figures) as the second height h₂ of the second side 58 in this embodiment, in an alternative embodiment the second passageway may extend from the upper opening towards the lower surface, but not fully extend to the lower surface. In such an embodiment, the lower surface does not define a lower opening; instead, the second passageway has an upper opening opposite a floor. In alternative embodiments, the second passageway may define a height that is equal to, about equal to, or less than the second height of the second side. In other embodiments, the upper opening may be square, rectangular, trapezoidal, triangular, ovoid, elliptical, or any other shape. In different embodiments, the lower opening may be square, rectangular, trapezoidal, triangular, ovoid, elliptical, or any other shape. In addition, the lower opening may be shaped the same as, substantially the same as, or differently than the upper opening.

The inner surface 62 also defines a second threaded portion 84. The second threaded portion 84 extends along the entire inner surface 62 and is configured to mate with the first threaded portion 44 of the inner member 20. The second threaded portion 84 is integrally formed with the second side 58 of the main body 52 in the illustrated embodiment. A skilled artisan will be able to select a suitable configuration for the second threaded portion according to a particular example based on various considerations, including the size and shape of the inner member, the plant that will be housed by the inner member, and the liquid into which the buoyant device is placed. In an alternative embodiment, the second threaded portion may extend along the inner surface from the upper surface towards the lower surface to about 10 percent to about 70 percent of the height (not illustrated in the Figures) of the inner surface. In a different embodiment, the second threaded portion may extend along the inner surface from the upper surface towards the lower surface to about 25 percent to about 55 percent of the height (not illustrated in the Figures) of the inner surface. In another embodiment, the second threaded portion may extend along the inner surface from the upper surface towards the lower surface to about 35 percent to about 45 percent of the height (not illustrated in the Figures) of the inner surface. Additionally, in alternative embodiments, rather than being integrally formed with the inner surface, the second threaded portion may be attached to the inner surface via an adhesive, a mechanical structure, welding, or any other suitable attachment mechanism. In other embodiments, neither the inner surface of the outer member nor the first side of the inner member has a first threaded portion or a second threaded portion, respectively. Instead, the inner surface and the first side may, for example, contain snap-fit mechanisms that allow the inner surface of the outer member to be attached to the first side of the inner member. Furthermore, one or both of the inner surface of the outer member and the first side of the inner member may be coated in an adhesive to attach the inner and outer members. Mechanical structures, welding, or any other suitable technique may also attach the first side of the inner member to the inner surface of the outer member.

As best illustrated in FIG. 2, the inner surface 62 defines a third diameter d₃ extending through the central longitudinal axis of the outer member 50 from a fifth point 61 disposed where the upper surface 54 is adjacent the inner surface 62 to a sixth point 63 where the upper surface 54 is adjacent the inner surface 62. The third diameter d₃ is constant along the entire second passageway 60 from the upper surface 54 to the lower surface 56 and is greater than the second diameter d₂ in the illustrated embodiment. The third diameter d₃ may have any suitable measurement, however. A skilled artisan will be able to select a suitable third diameter according to a particular example based on various considerations, including the size and shape of the inner member, the plant that will be housed by the inner member, and the liquid into which the buoyant device is placed. In an alternative embodiment, the third diameter may taper from the upper surface to the lower surface. In a different embodiment, the third diameter may taper from the lower surface to the upper surface. Alternatively, the third diameter may first taper, and then expand from the upper surface to the lower surface.

The upper surface 54 defines a fourth diameter d₄ extending through the central longitudinal axis from a seventh point 64 disposed where the upper surface 54 is adjacent the second side 58 to an eighth point 66 where the upper surface 54 is adjacent the second side 58. The fourth diameter d₄ is constant along the entire second side 58 from the upper surface 54 to the lower surface 56 in the illustrated embodiment. The fourth diameter d₄ is greater than the third diameter d₃ in the illustrated embodiment. The fourth diameter d₄ may have any suitable measurement, however. A skilled artisan will be able to select a suitable fourth diameter according to a particular example based on various considerations, including the size and shape of the inner member, the plant that will be housed by the inner member, and the liquid into which the buoyant device is placed. In an alternative embodiment, the fourth diameter may taper from the upper surface to the lower surface. In a different embodiment, the fourth diameter may taper from the lower surface to the upper surface. Alternatively, the fourth diameter may first taper, and then expand from the upper surface to the lower surface. Additionally, the third diameter may be between about 10 percent and about 50 percent as great as the fourth diameter in other embodiments. In alternative embodiments, the third diameter may be between about 20 percent and about 40 percent as great as the fourth diameter. In different embodiments, the third diameter may be between about 25 percent and about 35 percent as great as the fourth diameter.

Each of FIGS. 5 and 6 illustrate the first example buoyant device 10 described above and illustrated in FIGS. 1 through 4 with an associated plant 2.

The plant includes a plurality of roots 4, a leafy section 6, and a stem 8 extending from the plurality of roots 4 to the leafy section 6. The plant 2 illustrated in FIGS. 5 and 6 is a generic plant 2. Any suitable plant may be used in connection with the buoyant device 10. A skilled artisan will be able to select an appropriate plant to use in conjunction with the buoyant device according to a particular example based on various considerations, including the composition of and location of the liquid into which the buoyant device will be placed and the size and shape of the inner member and the outer member. Examples of suitable plants include tomato plants, potato plants, any type of fruit-bearing plant, any type of vegetable-bearing plant, or one or more grasses. Furthermore, soil, foam impregnated with soil, a mechanical filtration device, or any other item or device may be used in place of a plant.

The plant 2 is housed in the first passageway 30 of the inner member 20 and is held in place by the plurality of teeth 38. Specifically, the plurality of teeth 38 contacts the stem 8 of the plant 2 to hold the plant 2 in place within the first passageway 30 of the inner member 20. The plant 2 may be held in place via any suitable mechanism, though. A skilled artisan will be able to select an appropriate mechanism for holding the plant within the first passageway according to a particular example based on various considerations, including the composition of and location of the liquid into which the buoyant device will be placed, the size and shape of the plant, and the size and shape of the inner member and outer member. In an alternative embodiment, the inner surface of the inner member may be coated with an adhesive that can adhere the plant to the inner member upon contact between the stem of the plant and the inner surface. In another embodiment, the stem of the plant may be coated with an adhesive that can adhere the plant to the inner member upon contact between the stem of the plant and the inner surface. In a different embodiment, the inner surface may define a threaded portion configured to mate with a thread attached to the stem of the plant. Moreover, any other mechanical structure for attaching the plant to the inner surface of the inner member may be used in other embodiments.

In the illustrated embodiment, each of the plurality of roots 4 is disposed beneath the lower surface 56 of the inner member 50 and is, thus, fully disposed outside of the first passageway 30. The plurality of roots 4 is disposed as such to ensure that the plurality of roots 4 is disposed substantially continuously in a liquid (not illustrated in the Figures). Substantially continuous contact between the plurality of roots 4 and a liquid allows for the plurality of roots 4 to efficiently absorb excess nutrients disposed in the liquid; such excess nutrients may include, for example, ammonia, nitrites, nitrates, phosphates, or other similar compounds. Each of the plurality of roots 4 may be fully disposed outside of the first passageway 30; they also may be partially disposed within the first passageway 30. A skilled artisan will be able to select how to dispose the plurality of roots with respect to the first passageway according to a particular example based on various considerations, including the composition of and location of the liquid into which the buoyant device will be placed, the size and shape of the plant, and the size and shape of the inner member and outer member. In another embodiment, only a portion of each of the plurality of roots may extend into the liquid; the other portion may be disposed within the first passageway. In an alternative embodiment, a mesh cage may be attached to the lower surface and surround the plurality of roots.

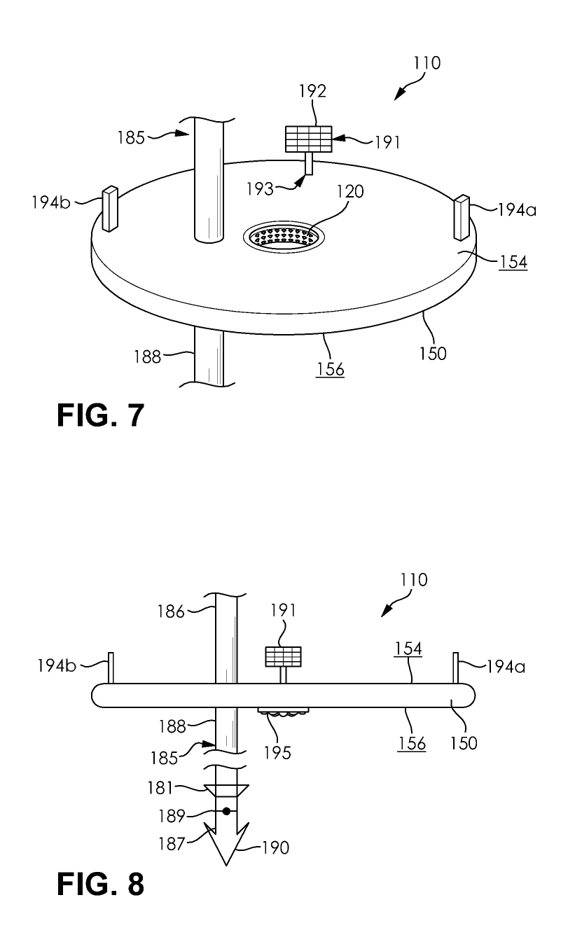

Each of FIGS. 7 and 8 illustrates another example buoyant device 110. The buoyant device 110 is similar to the buoyant device 10 illustrated in FIGS. 1, 2, 3, and 4 and described above, except as described below. Thus, the buoyant device 110 comprises an inner member 120 releasably attached to an outer member 150.

In the illustrated embodiment, the upper surface 154 and the lower surface 156 cooperatively define a channel defining an inner surface (not illustrated in the Figures) that extends from the upper surface 154 to the lower surface 156 of the outer member 150. The upper surface 154 defines an upper opening (not illustrated in the Figures) and the lower surface 156 defines a lower opening (not illustrated in the Figures). Each of the upper opening and the lower opening is circular in shape and the diameter of the upper opening is equal to the diameter of the lower opening (not illustrated in the Figures). Furthermore, the channel has a constant diameter from the upper opening to the lower opening. The channel may have one or more diameters, however, and each of the upper opening and the lower opening may have different diameters and shapes. A skilled artisan will be able to select suitable shapes for the upper and lower openings and one or more diameters for the channel according to a particular example based on various considerations, including the size and shape of the inner member, the plant that will be housed by the inner member, and the liquid into which the buoyant device is placed. Examples of suitable shapes for the upper and lower openings include elliptical, square, rectangular, ovoid, or any other suitable shape. In other embodiments, the upper opening may have a diameter that is larger than, smaller than, or substantially equal to the diameter of the lower opening. In addition, in alternative embodiments, the diameter of the channel may not be constant.

As best illustrated in FIGS. 7 and 8, a pile 185 extends through the channel (not illustrated in the Figures) and is releasably attached to the inner surface of the channel (not illustrated in the Figures). The pile comprises a proximal end 186, a distal end 187, and a main body 188 extending from the proximal end 186 to the distal end 187. The main body 188 of the pile 185 is releasably attached to the inner surface of the channel via an adhesive disposed on the main body 188. The pile 185 may be releasably attached to the inner surface of the channel by any suitable technique, however. A skilled artisan will be able to select a suitable technique for releasably attaching the pile to the inner surface of the channel according to a particular example based on various considerations, including the size and shape of the pile, the plant that will be housed by the inner member, and the liquid into which the buoyant device is placed. Examples of suitable techniques for releasably attaching the pile to the inner surface of the channel include through the use of a mechanical structure, welding, or any other suitable attachment mechanism.

In the illustrated embodiment, a sensor 181 and a locator beacon 189 are disposed on the main body 188 distal to the lower surface 156 of the outer member 150. The sensor 181 is configured to locate a cleat (not illustrated in the Figures). The locator beacon 189 is configured to magnetically locate A skilled artisan will be able to select whether to dispose one or more sensors to the main body and whether to dispose one or more locator beacons to the main body according to a particular example based on various considerations, including the size and shape of the pile, the plant that will be housed by the inner member and the liquid into which the buoyant device is placed. In another embodiment, zero, two, or greater than two sensors may be disposed on the main body. In a different embodiment, zero, two, or greater than two locator beacons may be disposed on the main body.

FIG. 8 illustrates the distal end 187 of the pile 185. The distal end 187 comprises an anchor 190. The anchor 190 is arrowhead-shaped and configured to contact a surface, such as the bed of a body of water such as a lake, river, ocean, or creek, for example, (not illustrated in the Figures) to stop the movement of the buoyant device 110 when the buoyant device 110 is placed in a liquid. The distal end 187 may have any suitable shape, however. A skilled artisan will be able to select a suitable shape for the distal end according to a particular example based on various considerations, including the size and shape of the pile, the plant that will be housed by the inner member, and the liquid into which the buoyant device is placed. Examples of suitable shapes for the distal end include triangular, elliptical, anchor, rectangular, trapezoid, and square.

FIGS. 7 and 8 also illustrate a solar panel 191 attached to the upper surface 154 of the outer member 150. The solar panel 191 comprises a base 193 and a cell 192 attached to the base 193. The base 193 is substantially tower-shaped; the cell 192 is rectangular. The solar panel 191 is welded to the upper surface 154 and is operably connected to each of the light sources and the air compressor disposed on the buoyant device 110 (described below). The solar panel 191 is operably connected to the light sources and the air compressor via a series of wires (not illustrated in the Figures) disposed within the main body 152 of the outer member 150. The cell 192 is configured to harness sunlight and allow the solar panel 193 to transform the sunlight into energy. This energy is passed from the solar panel 191 to the light sources and air compressor and provides their power. Each of the cell 192 and the base 193 may have any shape; furthermore, the solar panel 191 may be operably connected to any one of a number of devices via any suitable method of connection. A skilled artisan will be able to select suitable shapes for the cell and the base and determine how to suitably connect the solar panel to other devices according to a particular example based on various considerations, including the number of devices to which the solar panel will be operably connected, the plant that will be housed by the inner member, and the liquid into which the buoyant device is placed. Examples of suitable shapes for the base include pyramidal, cubical, trapezoidal, and egg. Examples of suitable shapes for the cell include elliptical, square, trapezoidal, and circular. The solar panel may be operably connected to the light sources, air compressor, or any other device via wires that are disposed on the lower surface, upper surface, or second side of the outer member, or through direct contact between a device and the solar panel. Additionally, the solar panel may be attached to the upper surface through a mechanical attachment or an adhesive, rather than welded to the upper surface.

The illustrated embodiment also includes first and second light sources 194a, 194b disposed on the upper surface 154 of the outer member 150. The light sources 194a, 194b are tower-shaped and are powered by the solar panel 191, as described above. The first light source 194a is substantially opposite the second light source 194b about the inner member 120. The light sources 194a, 194b are visible at night and enable tracking of the buoyant device 110 in darkness. Any type of light may be used as a light source 194a, 194b. A skilled artisan will be able to select suitable light sources according to a particular example based on various considerations, including the number of devices to which the solar panel will be operably connected, the plant that will be housed by the inner member, and the liquid into which the buoyant device is placed. Examples of suitable light sources include for example, blue, red, and green LED lights. In addition, in other embodiments, zero, one, three, or more than three light sources may be disposed on the upper surface, second side, or lower surface of the outer member.

An air compressor 195 is also illustrated in FIG. 8. The air compressor 195 is disposed on the lower surface 156 of the outer member 150 and is powered by the solar panel 191, as described above. The air compressor 195 may be disposed anywhere on the outer member 150. A skilled artisan will be able to select whether to include the air compressor according to a particular example based on various considerations, including the number of devices to which the solar panel will be operably connected, the plant that will be housed by the inner member, and the liquid into which the buoyant device is placed. In other embodiments, the air compressor may be disposed on the upper surface or the second side of the outer member.

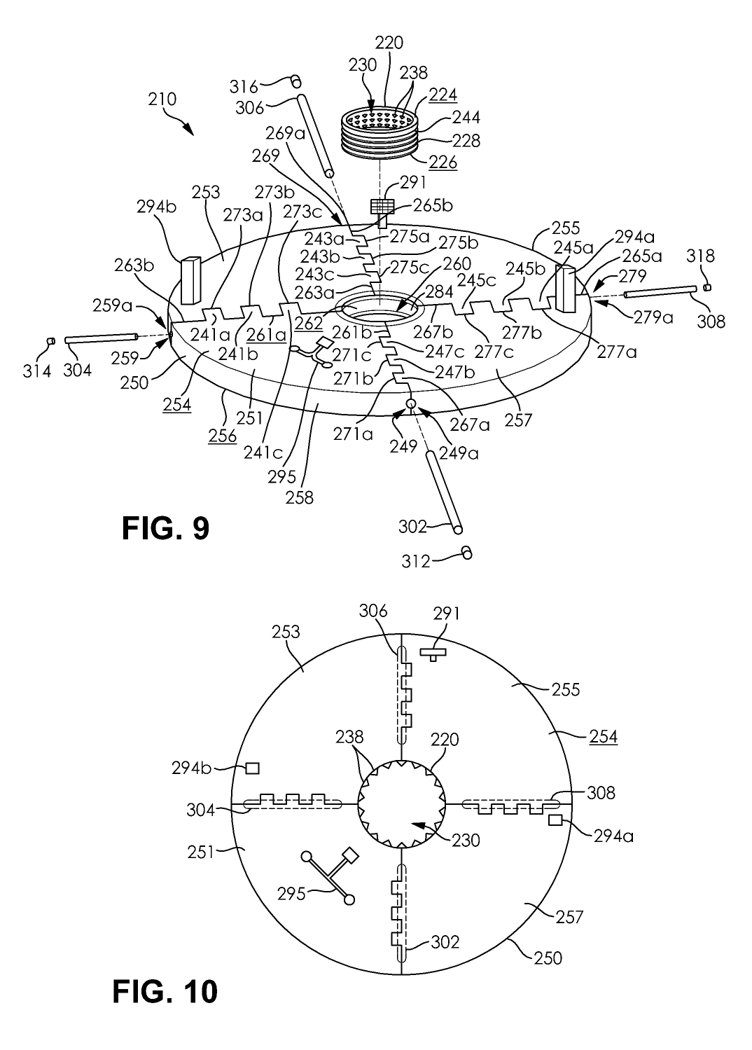

Each of FIGS. 9 and 10 illustrate another example buoyant device 210. The buoyant device 210 is similar to the buoyant device 110 illustrated in FIGS. 7 and 8 and described above, except as described below. Thus, the buoyant device 210 comprises an inner member 220 releasably attached to an outer member 250.

The inner member 220 is similar to the inner member 10 described above. Thus, the inner member 220 includes an upper surface 224, a lower surface 226, a first side 228, a first passageway 230, an inner surface 232, a plurality of teeth 238, and a first threaded portion 244.

In the illustrated embodiment, the outer member 250 is comprised of first, second, third, and fourth portions 251, 253, 255, 257 (collectively referred to as “the four portions 251, 253, 255, 257”). The first portion 251 includes a first edge 261a and a second edge 261b. The first edge 261a includes three protrusions 241a, 241b, 241c, while the second edge 261b includes three indentations 271a, 271b, 271c. The second portion 253 includes a first edge 263a and a second edge 263b. The first edge 263a includes three protrusions 243a, 243b, 243c, while the second edge 263b includes three indentations 273a, 273b, 273c. The third portion 255 includes a first edge 265a and a second edge 265b. The first edge 265a includes three protrusions 245a, 245b, 245c, while the second edge 265b includes three indentations 275a, 275b, 275c. The fourth portion 257 includes a first edge 267a and a second edge 267b. The first edge 267a includes three protrusions 247a, 247b, 247c, while the second edge 267b includes three indentations 277a, 277b, 277c. The first edge 261a of the first portion 251 is configured to mate with the second edge 263b of the second portion 253. The first edge 263a of the second portion 253 is configured to mate with the second edge 265b of the third portion 255. The first edge 265a of the third portion 255 is configured to mate with the second edge 267b of the fourth portion 257. The first edge 267a of the fourth portion 257 is configured to mate with the second edge 261b of the first portion 251. The outer member 250 may be comprised of any number of portions, however. A skilled artisan will be able to select a suitable number of portions based on various considerations, including the size and shape of the inner member, the plant that will be housed by the inner member, and the liquid into which the buoyant device is placed. In other embodiments, one, two, three, five, or more than five portions may comprise the outer member.

When the four portions 251, 253, 255, 257 mate as described above, they cooperatively form a disc-shaped outer member 250. The four portions 251, 253, 255, 257 also cooperatively define an upper surface 254, a lower surface 256, a second side 258 extending from the upper surface 254 to the lower surface 256, and a second threaded portion 284 configured to mate with the first threaded portion 244. The upper surface 254 and the lower surface 256 are each circular in the illustrated embodiment. A skilled artisan will be able to select suitable shapes for the outer member, the upper surface, and the lower surface according to a particular example based on various considerations, including the size and shape of the outer member, the plant that will be housed by the inner member, and the liquid into which the buoyant device is placed. In alternative embodiments, the outer member may be bucket-shaped, egg-shaped, pyramid-shaped, cube-shaped, or have any other shape. In other embodiments, the upper surface may be square, rectangular, trapezoidal, triangular, ovoid, elliptical, or any other shape. In different embodiments, the lower surface may be square, rectangular, trapezoidal, triangular, ovoid, elliptical, or any other shape. In addition, the lower surface may be shaped the same as, substantially the same as, or differently than the upper surface.

The upper surface 254 and the lower surface 256 cooperatively define a second passageway 260 that extends from the upper surface 254 to the lower surface 256 about the central longitudinal axis (not illustrated in the Figures) of the outer member 250. An inner surface 262 is defined by the second passageway 260 and extends from the upper surface 254 to the lower surface 256. The inner surface 262 and the upper surface 254, thus, cooperatively define an upper opening 280 and the inner surface 262 and the lower surface 256 cooperatively define a lower opening 282. Each of the upper and lower openings 280, 282 is circular in the illustrated embodiment. The upper and lower openings 280, 282 may have any shape, however. A skilled artisan will be able to select whether to extend the second passageway from the upper surface to the lower surface according to a particular example based on various considerations, including the size and shape of the inner member, the plant that will be housed by the inner member, and the liquid into which the buoyant device is placed. Though the second passageway 260 extends from the upper surface 254 to the lower surface 256 in this embodiment, in an alternative embodiment the second passageway may extend from the upper opening towards the lower surface, but not fully extend to the lower surface. In such an embodiment, the lower surface does not define a lower opening; instead, the second passageway has an upper opening opposite a floor. In alternative embodiments, the second passageway may define a height (not illustrated in the Figures) that is equal to, about equal to, or less than the height (not illustrated in the Figures) of the second side. In other embodiments, the upper opening may be square, rectangular, trapezoidal, triangular, ovoid, elliptical, or any other shape. In different embodiments, the lower opening may be square, rectangular, trapezoidal, triangular, ovoid, elliptical, or any other shape. In addition, the lower opening may be shaped the same as, substantially the same as, or differently than the upper opening.

The outer member 250 defines first, second, third, and fourth channels 249, 259, 269, 279 (collectively referred to as “the four channels 249, 259, 269, 279”). The first channel 249 is cooperatively defined by the second edge 261b of the first portion 251, the first edge 267a of the fourth portion 257, and the second side 258. The second channel 259 is cooperatively defined by the first edge 261a of the first portion 251, the second edge 263b of the second portion 253, and the second side 258. The third channel 269 is cooperatively defined by the first edge 263a of the second portion 253, the second edge 265b of the third portion 255, and the second side 258. The fourth channel 279 is cooperatively defined by the first edge 265a of the third portion 255, the second edge 267b of the fourth portion 257, and the second side 258. None of the four channels 249, 259, 269, 279, however, extend to the inner surface 262 of the outer member 250. Additionally, each of the four channels 249, 259, 269, 279 defines a first, a second, a third, and a fourth opening 249a, 259a, 269a, 279a, respectively. Each of the first, second, third, and fourth openings 249a, 259a, 269a, 279a is circular in shape and is configured to house a rod (described below). The outer member 250 may define any number of channels that define openings having any shape, however. A skilled artisan will be able to select a suitable number of channels and suitable shapes for their openings according to a particular example based on various considerations, including the size and shape of the inner member, the plant that will be housed by the inner member, and the liquid into which the buoyant device is placed. In other embodiments, the outer member may define zero, one, two, three, five, or more than five channels. In different embodiments, the openings may be square, rectangular, trapezoidal, triangular, ovoid, elliptical, or any other shape. In addition, any individual opening may be shaped the same as, substantially the same as, or differently than any other individual opening.

FIGS. 9 and 10 also illustrate first, second, third, and fourth rods 302, 304, 306, 308 (collectively referred to as “the four rods 302, 304, 306, 308”). In the illustrated embodiment, the four rods 302, 304, 306, 308 releasably attach one of the four portions 251, 253, 255, 257 to another of the four portions 251, 253, 255, 257. Thus, for example, the first rod 302 is inserted into the first channel 249 and releasably attaches the first portion 251 to the fourth portion 257. The second rod 304 is inserted into the second channel 259 and releasably attaches the first portion 251 to the second portion 253. The third rod 306 is inserted into the third channel 269 and releasably attaches the second portion 253 to the third portion 255. The fourth rod 308 is inserted into the fourth channel 279 and releasably attaches the third portion 255 to the fourth portion 257. In addition, first, second, third, and fourth caps 312, 314, 316, 318 (collectively referred to as “the four caps 312, 314, 316, 318”) are releasably attached to the second side 258 adjacent the first, second, third, and fourth openings 249a, 259a, 269a, 279a, respectively, to seal the four rods 302, 304, 306, 308 within their respective channels 249, 259, 269, 279. Each of the caps 312, 314, 316, 318 is disc-shaped in the illustrated embodiment and is attached to the second side 258 via a snap-fit mechanism (not illustrated in the Figures). One of the four portions 251, 253, 255, 257 of the outer member 250 may be attached to another of the four portions 251, 253, 255, 257 via any suitable technique, however. Furthermore, if the four rods 312, 314, 316, 318 are utilized, the caps 312, 314, 316, 318 may be secured to the second side 258 via any means. A skilled artisan will be able to select whether to include the four rods and the four caps or how to otherwise suitably attach the four portions of the outer member according to a particular example based on various considerations, including the size and shape of the inner member, the plant that will be housed by the inner member, and the liquid into which the buoyant device is placed. Examples of suitable ways to connect one of the four portions to another of the four portions include through the use of adhesives, a mechanical structure, or welding. In addition, if the four rods are utilized, the caps may be attached to the second side through the use of adhesives, a mechanical structure, or welding.

FIGS. 9 and 10 illustrate various devices attached to the upper surface 254 of the outer member 250. The second and fourth portions 253, 257 include first and second light sources 294a, 294b, respectively. The first portion 251 includes an air compressor 295 disposed on the upper surface 254 and the third portion 255 includes a solar panel 291 disposed on the upper surface 254. Each of the four portions 251, 253, 255, 257 may include one or more solar panels 291, air compressors 295, or light sources 294a, 294b. A skilled artisan will be able to determine whether to include a solar panel, an air compressor, or light sources on the upper surface based on various considerations, including the size and shape of the outer member, the plant that will be housed by the inner member, and the liquid into which the buoyant device is placed.

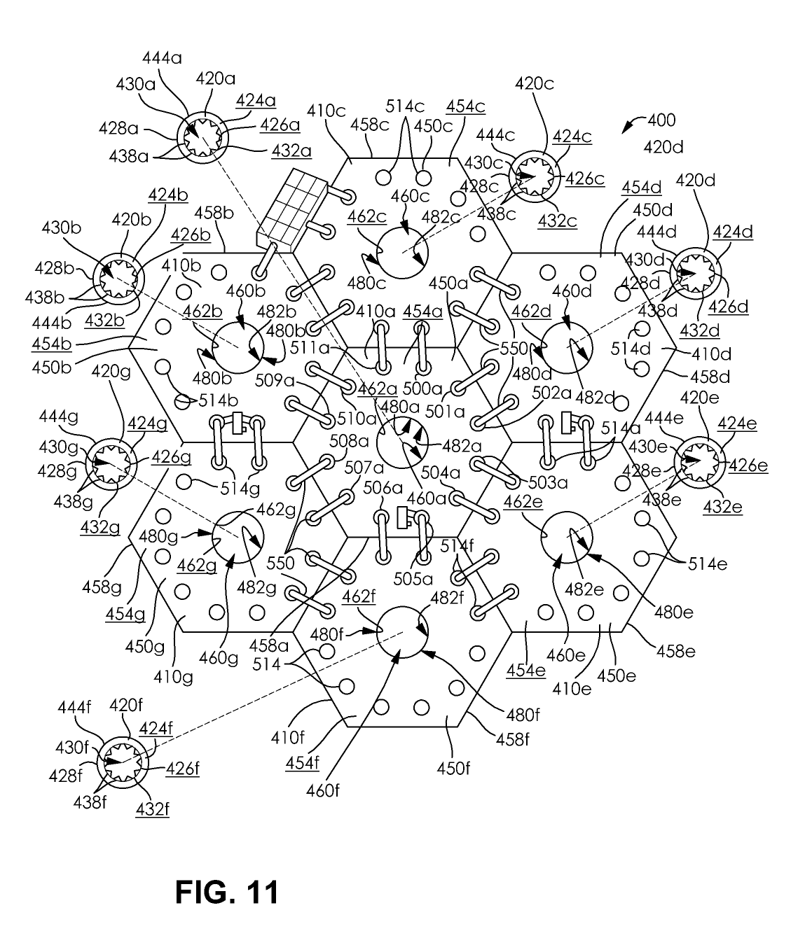

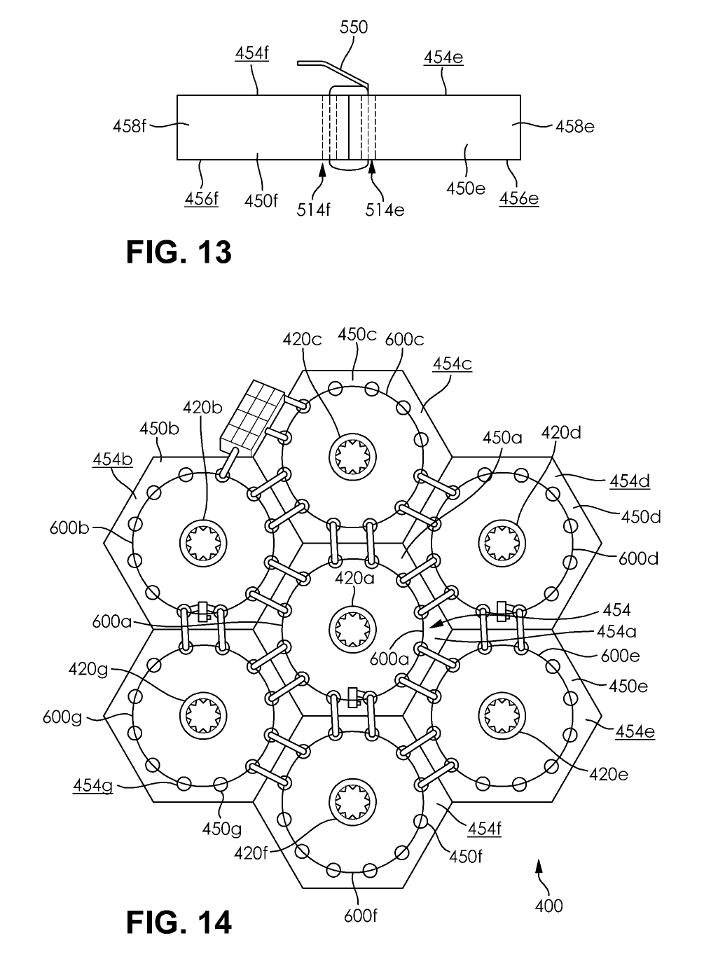

Each of FIGS. 11, 12, and 13 illustrates an example buoyant system 400. The buoyant system 400 is comprised of first, second, third, fourth, fifth, sixth, and seventh buoyant devices 410a, 410b, 410c, 410d, 410e, 410f, 410g (collectively referred to as “the buoyant devices 410a, 410b, 410c, 410d, 410e, 410f, 410g”), each of which is similar to the buoyant device 110 illustrated in FIGS. 1, 2, 3, and 4, except as described below. Therefore, the buoyant devices 410a, 410b, 410c, 410d, 410e, 410f, 410g each comprise an inner member releasably attached, respectively, to an outer member.

Each of the first, second, third, fourth, fifth, sixth, and seventh inner members 420a, 420b, 420c, 420d, 420e, 420f, 420g (collectively referred to as “the inner members 420a, 420b, 420c, 420d, 420e, 420f, 420g”) is similar to inner member 120 described above. Thus, each of the inner members 420a, 420b, 420c, 420d, 420e, 420f, 420g includes, respectively, an upper surface 424a, 424b, 424c, 424d, 424e, 424f, 424g, a lower surface 426a, 426b, 426c, 426d, 426e, 426f, 426g, a first side 428a, 428b, 428c, 428d, 428e, 428f, 428g, a first passageway 430a, 430b, 430c, 430d, 430e, 430f, 430g, an inner surface 432a, 432b, 432c, 432d, 432e, 432f, 432g, a plurality of teeth 438a, 438b, 438c, 438d, 438e, 438f, 438g, and a first threaded portion 444a, 444b, 444c, 444d, 444e, 444f, 444g.

Each of the first, second, third, fourth, fifth, sixth, and seventh outer members 450a, 450b, 450c, 450d, 450e, 450f, 450g (collectively referred to as “the outer members 450a, 450b, 450c, 450d, 450e, 450f, 450g”) is similar to outer member 150, except as described below. Thus, each of the outer members 450a, 450b, 450c, 450d, 450e, 450f, 450g includes, respectively, an upper surface 454a, 454b, 454c, 454d, 454e, 454f, 454g, a lower surface 456a, 456b, 456c, 456d, 456e, 456f, 456g, a second side 458a, 458b, 458c, 458d, 458e, 458f, 458g, a second passageway 460a, 460b, 460c, 460d, 460e, 460f, 460g, an inner surface 462a, 462b, 462c, 462d, 462e, 462f, 462g, an upper opening 480a, 480b, 480c, 480d, 480e, 480f, 480g, and a lower opening 482a, 482b, 482c, 482d, 482e, 482f, 482g.

The upper surface 454a of the first outer member 450a is hexagonal in shape in this embodiment; the lower surface (not illustrated in the Figures) is also hexagonal in shape in this embodiment. The upper surface 454a of the first outer member 450a is the same size as the lower surface of the first outer member 450a, as well. Thus, the second side 458a is perpendicular to the upper surface 454a and the lower surface 456a. Each of the upper surface 454a and the lower surface may have any shape and size, however. A skilled artisan will be able to select suitable shapes for the upper surface and the lower surface according to a particular example based on various considerations, including the size and shape of the outer members, the plants that will be housed by the inner members, and the liquid into which the buoyant system is placed. In other embodiments, the upper surface may be square, rectangular, trapezoidal, triangular, ovoid, elliptical, or any other shape. In different embodiments, the lower surface may be square, rectangular, trapezoidal, triangular, ovoid, elliptical, or any other shape. In addition, the lower surface may be shaped the same as, substantially the same as, or differently than the upper surface and may also be larger than, about equal to, or smaller than the upper surface.

The first outer member 450a also defines first, second, third, fourth, fifth, sixth, seventh, eighth, ninth, tenth, eleventh, and twelfth channels 500a, 501a, 502a, 503a, 504a, 505a, 506a, 507a, 508a, 509a, 510a, 511a (collectively referred to as “the plurality of channels 514a”). Each of the plurality of channels 514 extends from the upper surface 454a to the lower surface 456a of the first outer member 450a. Each of the plurality of channels 514a has a constant diameter from the upper surface 454a to the lower surface 456a and defines circular upper and lower openings (not illustrated in the Figures); furthermore, each of the plurality of channels 514a is the same size and shape as each other of the plurality of channels 514a and each of the upper and lower openings is same size and shape as each of the other upper and lower openings. Each of the plurality of channels 514a is configured to allow the insertion of a connecting member (described below). The first outer member 450a may define any number of channels, however; additionally, each channel may have any size and shape. A skilled artisan will be able to select a suitable number of channels and determine suitable shapes and sizes for the channels according to a particular example based on various considerations, including the size and shape of the outer members, the plants that will be housed by the inner members, and the liquid into which the buoyant system is placed. In other embodiments, the outer member may define zero, one, two, three, four, five, six, seven, eight, nine, ten, eleven, thirteen or more than thirteen channels. In alternative embodiments, each of the channels may define square, rectangular, elliptical, or triangular upper and lower openings and each upper or lower opening may have the same as or a different shape as any other upper or lower opening. In different embodiments, one or more of the channels may have non-constant diameters.

Each of the second outer member 450b, the third outer member 450c, the fourth outer member 450d, the fifth outer member 450e, the sixth outer member 450f, and the seventh outer member 450g is configured in the same manner as the first outer member 450a. The second outer member 450b, therefore, has a hexagonal upper surface 454b, a hexagonal lower surface 456b, and a plurality of channels 514b. The third outer member 450c has a hexagonal upper surface 454c, a hexagonal lower surface 456c, and a plurality of channels 514c. The fourth outer member 450d has a hexagonal upper surface 454d, a hexagonal lower surface 456d, and a plurality of channels 514d. The fifth outer member 450e has a hexagonal upper surface 454e, a hexagonal lower surface 456e, and a plurality of channels 514e. The sixth outer member 450f has a hexagonal upper surface 454f, a hexagonal lower surface 456f, and a plurality of channels 514f. The seventh outer member 450g has a hexagonal upper surface 454g, a hexagonal lower surface 456g, and a plurality of channels 514g. A skilled artisan will be able to select how suitably to size and shape each portion of the second through sixth outer members according to a particular example based on various considerations, including the size and shape of the inner members, the plants that will be housed by the inner members, and the liquid into which the buoyant system is placed. In other embodiments, each of the upper surfaces and lower surfaces may have any size and shape. In alternative embodiments, each of the second through seventh outer members may define any number of channels.

In the illustrated embodiment, the second side 458b of the second outer member 450b is adjacent to and in contact with each of the second side 458a of the first outer member 450a, the second side 458c of the third outer member 450c, and the second side 458g of the seventh outer member 450g. The second side 458c of the third outer member 450c is adjacent to and in contact with each of the second side 458a of the first outer member 450a, the second side 458b of the second outer member 450b, and the second side 458d of the fourth outer member 450d. The second side 458d of the fourth outer member 450d is adjacent to and in contact with each of the second side 458a of the first outer member 450a, the second side 458c of the third outer member 450c, and the second side 458e of the fifth outer member 450e. The second side 458e of the fifth outer member 450e is adjacent to and in contact with each of the second side 458a of the first outer member 450a, the second side 458d of the fourth outer member 450d, and the second side 458f of the sixth outer member 450f. The second side 458f of the sixth outer member 450f is adjacent to and in contact with each of the second side 458a of the first outer member 450a, the second side 458e of the fifth outer member 450e, and the second side 458g of the seventh outer member 450g. The second side 458g of the seventh outer member 450g is adjacent to and in contact with each of the second side 458a of the first outer member 450a, the second side 458f of the sixth outer member 450f, and the second side 458b of the second outer member 450b. Each of the outer members 450a, 450b, 450c, 450d, 450e, 450f, 450g may be disposed in any manner in relation to each of the outer members 450a, 450b, 450c, 450d, 450e, 450f, 450g, however. A skilled artisan will be able to select how suitably to align the outer members according to a particular example based on various considerations, including the size and shape of the outer members, the plants that will be housed by the inner members, and the liquid into which the buoyant system is placed. In another embodiment, each of the second sides of the outer members may contact each other second side of each other outer member. In a different embodiment, each of the second sides of the outer members may only contact one second side of one other outer member. In an alternative embodiment, each of the second sides of the outer members may not contact any other second sides of the other outer members.

Each of the second, third, fourth, fifth, sixth, and seventh outer members 450b, 450c, 450d, 450e, 450f, 450g is attached to the first outer member 450a via at least one connecting member 550 that extends through one of the plurality of channels 514a of the first outer member 450a and through one of the plurality of channels 514b, 514c, 514d, 514e, 514f, 514g defined by the respective second, third, fourth fifth, sixth, and seventh outer members 450b, 450c, 450d, 450e, 450f, 450g. However, the second, third, fourth, fifth, sixth, and seventh outer members 450b, 450c, 450d, 450e, 450f, 450g may be attached to the first outer member 450a via any suitable mechanism. A skilled artisan will be able to select how best to attach the second, third, fourth, fifth, sixth, and seventh outer members to the first outer member according to a particular example based on various considerations, including the size and shape of the connecting members, the plants that will be housed by the inner members, and the liquid into which the buoyant system is placed. In other embodiments, the first outer member may be attached to the other outer members via adhesives, magnets, or welding. In alternative embodiments, multiple connecting members may be inserted through one or more of the plurality of channels defined by the first outer member and one or more of the plurality of channels defined by the second, third, fourth, fifth, sixth, and seventh outer members. In addition, other embodiments exist in which the first outer member is attached to greater than or fewer than six other members. In the illustrated embodiment, the connecting members comprise zip ties; however, in other embodiments, any mechanical structure may comprise the connecting members.

As is also illustrated, each of the second, third, fourth, fifth, sixth, and seventh outer members 450b, 450c, 450d, 450e, 450f, 450g is attached to its adjacent second, third, fourth, fifth, sixth, and seventh outer members 450b, 450c, 450d, 450e, 450f, 450g via connecting members 550 that extend through at least two of the plurality of channels 514b, 514c, 514d, 514e, 514f, 514g. Thus, for example, the second outer member 450b is attached to the third and seventh outer members 450c, 450g through the use of connecting members 550. Similarly, the third outer member 450c is attached to the second and fourth outer members 450b, 450d, the fourth outer member 450d is attached to the third and fifth outer members 450c, 450e, the fifth 450e outer member is attached to the fourth and sixth outer members 450d, 450f, the sixth outer member 450f is attached to the fifth and seventh outer members 450e, 450g, and the seventh outer member 450g is attached to the sixth and second outer members 450g, 450b through the use of connecting members 550 that extend through the plurality of channels 514b, 514c, 514d, 514e, 514f, 514g defined by each of the second third, fourth, fifth, sixth, and seventh outer members 450b, 450c, 450d, 450e, 450f, 450g. However, the second, third, fourth, fifth, sixth, and seventh outer members 450b, 450c, 450d, 450e, 450f, 450g may be attached to one another via any suitable mechanism. A skilled artisan will be able to select how to suitably attach the second, third, fourth, fifth, sixth, and seventh outer members to one another according to a particular example based on various considerations, including the size and shape of connecting members, the plants that will be housed by the inner members, and the liquid into which the buoyant system is placed. In other embodiments, the second, third, fourth, fifth, sixth, and seventh outer members may be attached to one another via adhesives or welding. In alternative embodiments, multiple connecting members may be inserted through one or more of the plurality of channels defined by the second, third, fourth, fifth, sixth, and seventh outer members. In addition, other embodiments exist in which the second, third, fourth, fifth, sixth, and seventh outer members are not attached to one another.

Each of the inner members 420a, 420b, 420c, 420d, 420e, 420f, 420g is releasably attached to its respective outer member 450a, 450b, 450c, 450d, 450e, 450f, 450g in the same manner in which the inner member 20 is releasably attached to the outer member 50, as described above and illustrated in FIGS. 1, 2, 3, and 4. A skilled artisan will be able to select how best to releasably attach the inner members to the outer members according to a particular example based on various considerations, including the size and shape of the outer members, the plants that will be housed by the inner members, and the liquid into which the buoyant system is placed. Examples of suitable means of attaching the inner members to the outer members include through the use of an adhesive, via welding, or via a mechanical attachment.

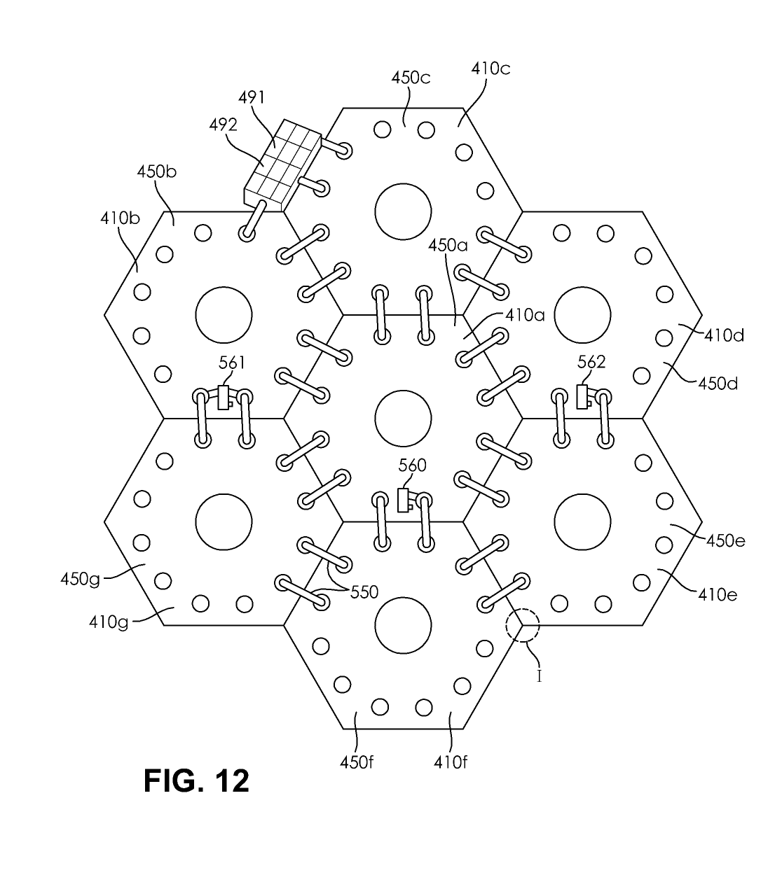

FIG. 12 also illustrates various devices attached to one or more of the outer members 450a, 450b, 450c, 450d, 450e, 450f, 450g. A solar panel 491 that is similar to solar panel 191 described above and illustrated in FIGS. 7 and 8, for example, is attached to each of the second and third outer members 450b, 450c via connecting members 550 that extend through the plurality of channels 514b, 514c defined by the second and third outer members 450b, 450c. The solar panel 491 is comprised solely of a cell 492 in the illustrated embodiment; the base of the solar panel 491 has been removed. The buoyant device also includes three air pumps 560, 561, 562 attached to the respective upper surfaces 454a, 454b, 454d of the first, second, and fourth outer members 450a, 450b, 450d. The three air pumps 560, 561, 562 are attached to the respective upper surfaces 454a, 454b, 454d via adhesives. A skilled artisan will be able to select whether to attach one or more devices to the buoyant system according to a particular example based on various considerations, including the size and shape of the outer members, the plants that will be housed by the inner members, and the liquid into which the buoyant system is placed. In an alternative example, each of the outer members includes a solar panel and an air pump. In a different example, none of the outer members includes a solar panel. In another embodiment, none of the outer members includes an air pump. Zero, one, two, four, or more than four air pumps may be included in other embodiments; zero, two, or more than two solar panels may be included in other embodiments, as well.

Each of FIGS. 14 and 15 illustrate the buoyant system 400 described above and illustrated in FIGS. 11 through 13 with associated cages 600a, 600b, 600c, 600d, 600e, 600f, 600g.

In the illustrated embodiment, a cage 600a, 600b, 600c, 600d, 600e, 600f, 600g is attached to each of the outer members 450a, 450b, 450c, 450d, 450e, 450f, 450g, respectively. Each of the cages 600a, 600b, 600c, 600d, 600e, 600f, 600g is circular in shape and is attached, respectively, to the upper surfaces 454a, 454b, 454c, 454d, 454e, 454f, 454g of the outer members 450a, 450b, 450c, 450d, 450e, 450f, 450g. The first, second, and fifth cages 600a, 600b, 600e each include an attached light source 494a, 494b, 494c, as well. Each of the outer members 450a, 450b, 450c, 450d, 450e, 450f, 450g may include a cage having any shape, however. A skilled artisan will be able to select a suitable shape for the cages and will be able to determine how many cages to attach to the buoyant system according to a particular example based on various considerations, including the size and shape of the outer members, the plants that will be housed by the inner members, and the liquid into which the buoyant system is placed. In other embodiments, zero, one, two, three, four, five, seven, or more than seven cages may be attached to the buoyant system. Additionally, any attached cage may be attached to any portion of the buoyant device. In alternative embodiments, the cages may be square, rectangular, trapezoidal, triangular, ovoid, elliptical, or any other shape. Different embodiments also exist in which the cages include zero, one, two, four, or greater than four light sources.

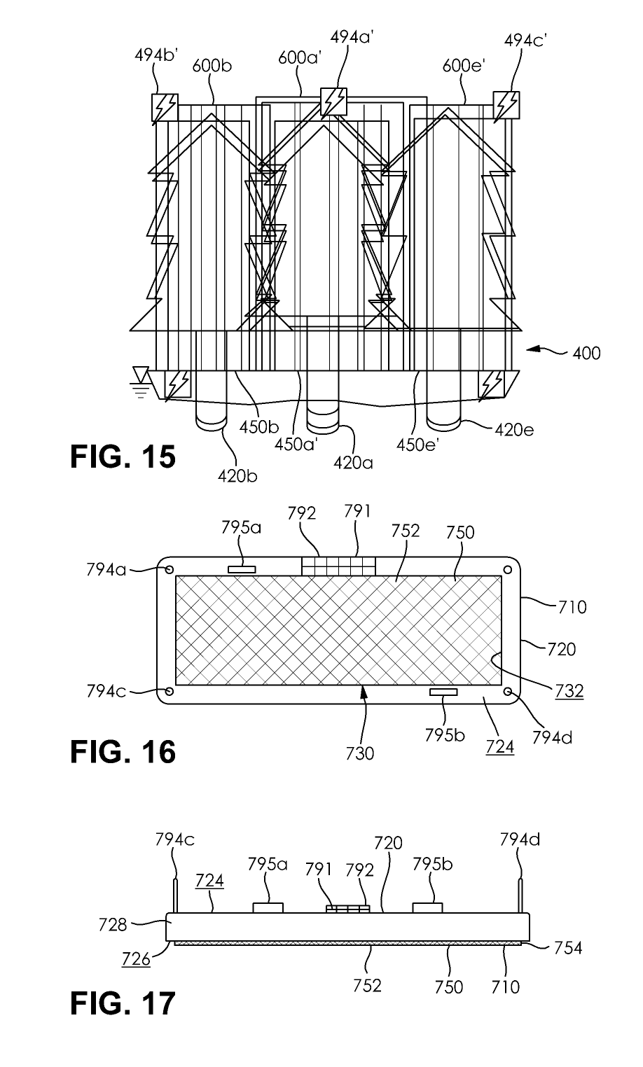

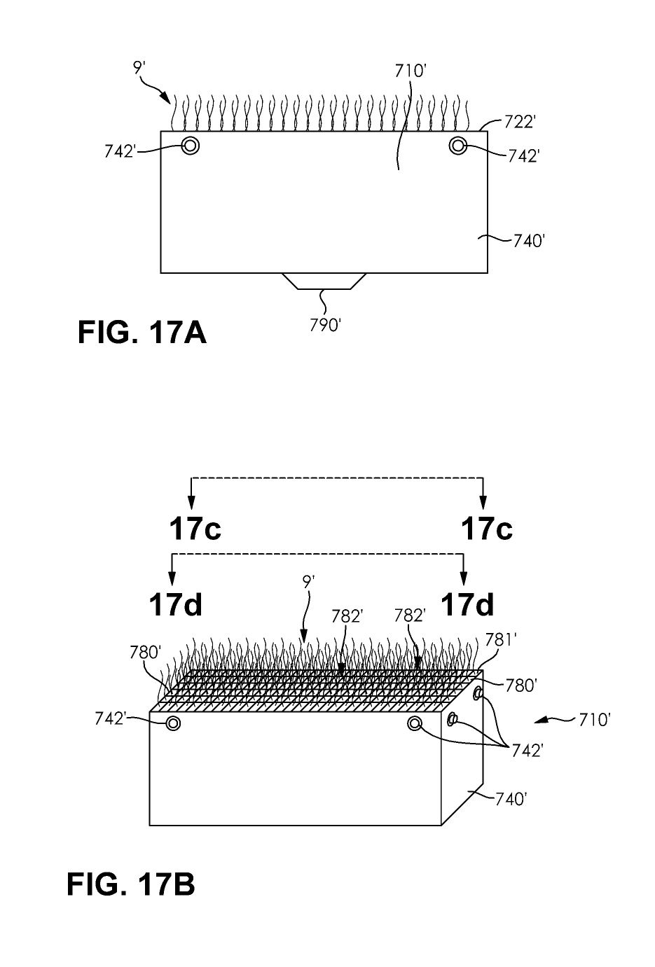

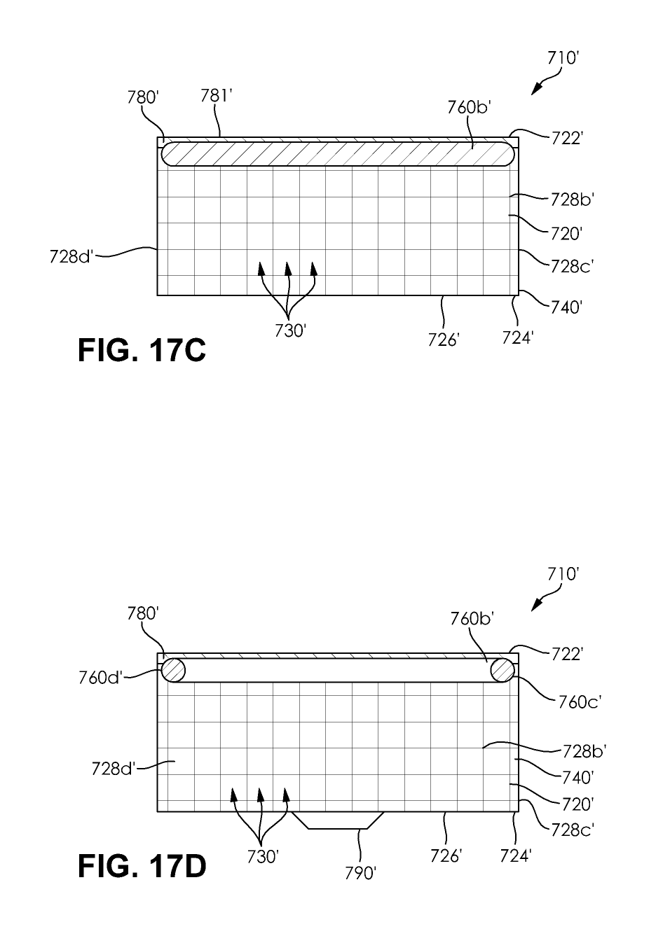

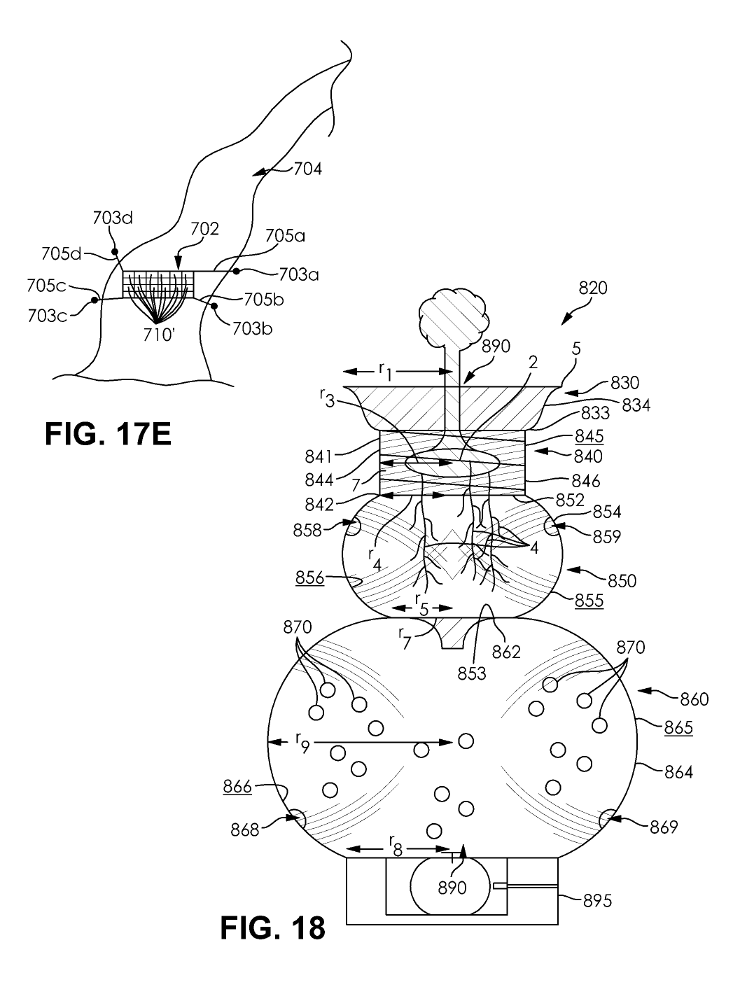

Each of FIGS. 16 and 17 illustrates another example buoyant device 710. The buoyant device 710 includes a raft 720 and a base 750. The base 750 is permanently attached to the raft 720.

The raft 720 includes a main body 722, an upper surface 724, a lower surface 726, a side 728 extending from the upper surface 724 to the lower surface 726, a window 730 extending from the upper surface 724 to the lower surface 726, and an inner surface 732 extending from the upper surface 724 to the lower surface 726.

The raft 720 and the window 730 are rounded rectangular in shape in the illustrated embodiment. Though the raft 720 and the window 730 are rounded rectangular in the illustrated embodiment, the raft 720 and window 730 may have any shape. A skilled artisan will be able to determine a suitable shape for each of the raft and the window in a particular example based on various considerations, including the size and shape of the base, the dimensions of the window, and the liquid into which the buoyant device will be placed. Other example shapes for the raft and the window include rectangular, square, oval, elliptical, circular, and trapezoidal.

The base 750 includes a floor 752 and a side 754. The floor 752 and the side 754 are comprised of mesh, or a similar material, that allow for a plant or grass (not illustrated in the Figures) to be placed on the floor 754 such that the roots of the plant or grass extend through the mesh into a liquid (not illustrated in the Figures). The side 754 is attached to the inner surface 732 via an adhesive. In other embodiments, the base 750 may be comprised of other materials and the side 754 may be attached to the inner surface 732 via a different mechanism. A skilled artisan will be able to determine a suitable material for the floor and side and a suitable mechanism for attaching the side to the inner surface in a particular example based on various considerations, including the size and shape of the raft, the dimensions of the window, and the liquid into which the buoyant device will be placed. In a different embodiment, the floor or side may be made of a plastic containing pores. In another embodiment, the side may be attached to the inner surface via a mechanical attachment.

FIG. 16 best illustrates four light sources 794a, 794b, 794c, 794d attached to the upper surface 724 of the raft 720. The light sources 794a, 794b, 794c, 794d attached to the upper surface 724 are similar to the light sources 194a, 194b described above and illustrated in FIGS. 7 and 8. Also disposed on the upper surface 724 is a solar panel 791 comprising a cell 792 and two air compressors 795a, 795b. The solar panel 791 is similar to the solar panel 791 described above and illustrated in FIGS. 7 and 8, but does not include a base; air compressors 795a, 795b are also disposed on the upper surface 724 and are similar to the air compressor 295 described above and illustrated in FIGS. 7 and 8. The light sources 794a, 794b, 794c, 794d, solar panel 791, and air compressors 795a, 795b may be attached to any portion of the buoyant device 710. A skilled artisan will be able to determine a suitable position for the light sources, solar panel, and air compressors in a particular example based on various considerations, the size and shape of the raft, the dimensions of the window, and the liquid into which the buoyant device will be placed. In another embodiment, the buoyant device does not include any a solar panel, light source, or air compressor. In a different embodiment, a buoyant device includes only one of a solar panel, a light source, and an air compressor. In other embodiments, the buoyant device comprises multiple solar panels, air compressors, and light sources.

Each of FIGS. 17A, 17B, 17C, and 17D illustrates another example buoyant device 710′. The buoyant device 710′ includes a basket 720′, a first covering 740′, flotation devices 760b′, 760c′, 760d′, a second covering 780′, and a weight 790′.

The basket 720′ includes a proximal side 722′, a distal side 724′, a base 726′, and four walls 728b′, 728c′, 728d′ (one wall is not illustrated in the Figures). The basket 720′ is grated; that is, none of the base 726′ or walls 728b′, 728c′, 728d′ is solid. Instead, each of the base 726′ and walls 728b′, 728c′, 728d′ defines a plurality of windows 730′; each individual window is substantially square-shaped. Each of the plurality of windows 730′ is substantially the same size and shape as every other window of the plurality of windows 730′. The first wall (not illustrated in the Figures) and second wall 728b′ are each substantially rectangular in shape; the third and fourth walls 728c′, 728d′ are each substantially square in shape. The base 726′ is substantially rectangular in shape and also defines a plurality of windows 730′. A skilled artisan will be able to select how best to size and shape the basket in a particular example based on various considerations, including the liquid into which the buoyant device will be placed and the plant that will be used in conjunction with the buoyant device. In other embodiments, each of the walls can be rectangular, square, triangular, or have any other shape. Alternatively, one, two, three, or none of the walls may comprise a plurality of windows. The plurality of windows, in other embodiments, may be rectangular, circular, triangular, or have any other shape. Furthermore, in a different embodiment, the base may be solid, while the walls may comprise one or more windows.

The basket 720′ is typically packed with a grow medium (not illustrated in the Figures) that allows a plant, such as plant 9′ illustrated in the Figures and described below, to absorb nutrients through the grow medium after it has contacted a liquid. FIGS. 17C and 17D are illustrated without a grow medium in order to better show the components of the buoyant device 710′. The basket 720′ can be completely filled from the distal side 724′ to the proximal side 722′ with grow medium; it can also be partially filled with grow medium. A skilled artisan will be able to select how much and which grow medium to utilize in a particular example based on various considerations, including the liquid into which the buoyant device will be placed and the plant that will be used in conjunction with the buoyant device. Examples of suitable grow mediums include coconut coir, pearlite, Rockwool, straw, peat moss, gravel, sand, and other proprietary mediums.

The grow medium houses a plant 9′. The plant 9′ has roots (not illustrated in the Figures) that extend through the grow medium and obtain nutrients through the liquid that it contacts. The grow medium provides a substrate for nitro-bacteria (or, “Nitrobacters”) to attach. Nitrobacters convert excess ammonia disposed in the liquid in which the buoyant device 710′ is disposed to environmentally preferable nitrate. The plant 9′ illustrated in this embodiment differs from the plant 2 described above. A skilled artisan will be able to select a suitable plant in a particular example based on various considerations, including the liquid into which the buoyant device is disposed and the size and shape of the basket. Suitable plants include many grass species; a skilled artisan will be able to determine such a suitable species based on a particular geographic location in which the buoyant device is used. Other suitable plants can be those plants 2 described above. One, two, three, four, or more than four plants may be disposed in a buoyant device.

The buoyant device 710′ includes a first covering 740′ that is disposed about and covers the base 726′ and each of the walls 728b′, 728c′, 728d′. The first covering 740′ is configured such that it allows liquid, such as water disposed in a lake, stream, creek, or other similar body of water, through the covering 740′ and into the basket 720′. Said liquid will then contact the grow medium. The first covering 740′ is attached to the exterior of the basket 720′ through the use of an adhesive. The first covering 740′ also includes a plurality of rings 742′ that allow for the buoyant device 710′ to be attached to another buoyant device or to another type of device. Each of the plurality of rings 742′ is attached to the first covering 740′ via an adhesive. A skilled artisan will be able to select and configure a suitable first covering in a particular example based on various considerations, including the size and shape of the basket and the liquid into which the buoyant device will be placed. The first cover can be comprised of one or more of any material, including a geofabric material and a material such as jute, hemp, and burlap, for example. In alternative embodiments, the geofabric material may only cover one, two, or three walls; it may also not cover the base. Additionally, the first covering may contain any number of rings, which may be disposed on any portion of the first covering. The rings may be comprised of one or more of brass, stainless steel, titanium, a metal alloy, a plastic, a plastic alloy, and any other suitable material.

Flotation devices 760b′, 760c′, 760d′ (one flotation device is not illustrated in the Figures) are each disposed adjacent the proximal side 722′ of the basket 720′. The first flotation device (not illustrated in the Figures) is disposed adjacent the first wall of the basket 720a′. The second flotation device 760b′ is disposed adjacent the second wall 728b′ of the basket 720′. The third flotation device 760c′ is disposed adjacent the third wall 728c′ of the basket 720′. The fourth flotation device 760d′ is disposed adjacent the fourth wall 728d′ of the basket 720′. Each of the first, second, third, and fourth flotation devices 760b′, 760c′, 760d′ is attached to the basket 720′ via an adhesive. Additionally, each of the first, second, third, and fourth flotation devices 760b′, 760c′, 760d′ is disposed beneath the first covering 740′. That is, as illustrated in, for example, FIG. 17B, the flotation devices 760b′, 760c′, 760d′ are not visible on the exterior of the buoyant device 710′. Each of the flotation devices 760b′, 760c′, 760d′ is designed to prevent the proximal side 722′ of the basket 720′ and the plant 9′ (described below) from being submerged in a liquid. A skilled artisan will be able to select whether to include flotation devices and how many to include in a particular example based on various considerations, including the weight of the basket and the plant and grow medium. Zero, one, two, three, five, or more than five flotation devices may be used. The flotation devices may be disposed on the exterior of the first covering in other devices, as well. The flotation devices can also be placed at the base of the buoyant device, in another embodiment. The flotation devices, in various examples, may be comprised of any material, including one or more of a plastic, an encapsulated foam, rubber, and a plastic inflatable bladder.

The buoyant device 710′ also includes a second covering 780′ that is attached to the walls 728b′, 728c′, 728d′ and covers the grow medium. The second covering 780′ comprises a screen 781′ having a plurality of windows 782′ that are square-shaped. Each of the plurality of windows 782′ is large enough to allow a portion of the plant 9′ to grow through an individual window. A skilled artisan will be able to determine a suitable second covering in a particular example based on various considerations, including the size and shape of the plant and the size and shape of the basket. In a different embodiment, the second covering may define a plurality of windows that are one or more of rectangular, circular, and triangular, for example. In an alternative embodiment, the second covering may allow light, but not the plant to pass through one or more of the plurality of windows. In a different embodiment, the buoyant device may not contain a second covering. In other embodiments, the second covering may include one or more of a solar panel and a light source.

Optionally, and as illustrated in FIGS. 17A and 17D, the buoyant device 710′ may include an anchor 790′. The anchor is disposed adjacent the distal side 724′ of the basket 720′ and is attached to both the first covering 740′ and the base 726′ of the basket 720′. The anchor 790′ assists in maintaining the proximal side 722′ (the side containing the second covering 780′) of the buoyant device 710′ upright. The anchor 790′ is attached to the first covering 740′ and base 726′ via a mechanical attachment. A skilled artisan will be able to select a suitable anchor in a particular example based on various considerations, including the size and shape of the basket and the plant housed within the buoyant device. The buoyant device may include two, three, or more than three anchors; additionally, the anchors may be disposed anywhere on the buoyant device. The anchor also may be attached one or both of the base and first covering via an adhesive or suturing, rather than a mechanical attachment. In an alternative embodiment, the buoyant device may not include an anchor.

FIG. 17E illustrates a system of buoyant devices 702. The system of buoyant devices 702 is comprised of a plurality of buoyant devices; each of the plurality of buoyant devices is similar to buoyant device 710′, described above.

In the illustrated embodiment, an individual buoyant device 710′ is attached to at least one other individual buoyant device 710′ via one or more of the plurality of rings 742′ (described above) that are disposed on the first coverings 740′ of the buoyant devices 710′. A mechanical attachment (not illustrated in the Figures) can be connected to one of the plurality of rings 742′ of a first buoyant device 710′ and one of the plurality of rings 742′ of a second buoyant device 710′. These mechanical attachments, which may comprise zip ties or other similar devices (not illustrated in the Figures), hold together the system of buoyant devices 702. A skilled artisan will be able to select a suitable way to attach multiple buoyant devices in a particular example based on various considerations, including the liquid into which the system is placed and the size and shape of the buoyant devices. In a different embodiment, one or more buoyant devices may be attached to at least one other buoyant device via suturing or an adhesive, rather than via a mechanical attachment.

The system of buoyant devices 702 is placed within a liquid 704, such a river, stream creek, lake, or other similar body of water. The system of buoyant devices 702 may be attached to a plurality of stabilizing structures 703a, 703b, 703c, 703d that rest either in or near the liquid 704 to stabilize the system of buoyant devices 702 in the liquid 704. The system of buoyant devices 702 may be attached to the stabilizing structures 703a, 703b, 703c, 703d, which may include posts, stakes, or rods, via connecting mechanisms 705a, 705b, 705c, 705d. The connecting mechanisms 705a, 705b, 705c, 705d may be comprised of strings, ropes, or another similar materials and can be tied or mechanically attached to one or more of the individual buoyant devices 710′. A skilled artisan will be able to select suitable stabilizing structures and connecting mechanisms in a particular example based on various considerations, including the size and shape of the liquid into which the system of buoyant devices is placed and area in which the stabilizing structure will be placed. In other embodiments, the system of buoyant devices may be partially disposed on land, and partially disposed in a liquid. In another embodiment, zero, one, two, three, five, or more than five stabilizing structures and connecting mechanisms may be used in conjunction with a system of buoyant devices.

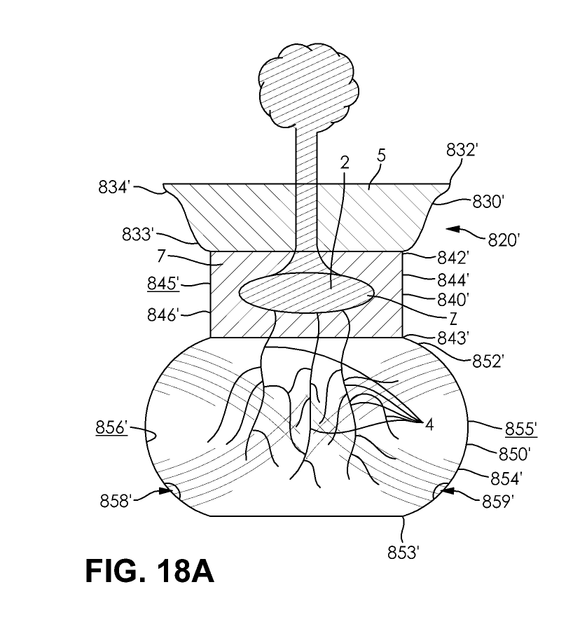

FIG. 18 illustrates another example inner member 820. The inner member 820 includes a first portion 830, a second portion 840, a third portion 850, and a fourth portion 860. The first, second, third, and fourth portions 830, 840, 850, 860 cooperatively form a first passageway 890 extending continuously through the first, second, third, and fourth portions 830, 840, 850, 860.

The first portion 830 has a proximal end 832, a distal end 833, and a curved lip 834 extending from the proximal end 832 to the distal end 833. The proximal end 832 and the distal end 833 are substantially parallel to one another and, respectively, define first and second radii r₁, r₂. The first radius r₁ is greater than the second radius r₂ in the illustrated embodiment. However, the proximal and distal ends 832, 833 may have any suitable first and second radii r₁, r₂. A skilled artisan will be able to select suitable first and second radii in a particular example based on various considerations, including the size and shape the plant that will be inserted into the inner member and the liquid into which a buoyant device that includes the inner member will be placed. In other embodiments, the first radius may be greater than, about equal to, or less than the second radius.

Optionally, the first portion 830 is a hollow cap designed to catch rain or splash water. The second portion 840 may be fully or partially filled with a material 5 that helps a plant seed (not illustrated) to germinate, and later provides frictional tension to help hold the plant 2 inside the inner member 820. A skilled artisan will be able to select a suitable material to place in the first portion based on various considerations, including the size and shape of the plant that will be inserted into the inner member and the liquid into which a buoyant device will be placed. In a particular embodiment, the material can be comprised of any material, including one or more of Rockwool, cotton, jute, hemp, and a proprietary substrate that mimics soil. Additionally, the first portion may contain no material in other embodiments.

The second portion 840 has a proximal end 842, a distal end 843, a side 844 extending from the proximal end 842 to the distal end 843, and an outer surface 845. In the illustrated embodiment, the second portion 840 and first portion 830 are connected such that the first and second portions 830, 840 are not separately moveable. Each of the proximal end 842, distal end 843, and side 844 define a third radius r₃ that is constant from the proximal end 842 to the distal end 843; the third radius r₃ is equal to the second radius r₂ defined by the distal end 834 of the first portion 830. However, the proximal end, distal end, and side 842, 843, 844 may have any suitable third radius r₃. A skilled artisan will be able to select a suitable third radius in a particular example based on various considerations, including the size and shape the plant that will be inserted into the inner member and the liquid into which a buoyant device that includes the inner member will be placed. In other embodiments, the third radius may be greater than, about equal to, or less than the second radius. In alternative embodiments, the proximal end may define a radius that is greater than, about equal to, or less than the radius of the distal end and the side. In another embodiment, the first and second portions may be separate components that are separately moveable.

The outer surface 845 of the second portion 840 defines a first threaded portion 846. The first threaded portion 846 is configured to mate with an outer member (not illustrated in the Figures), such as one of the outer members 50, 150, 250, 450 described above. Alternative embodiments exist in which the first threaded portion is replaced with an adhesive or a snap-fit structure.

The second portion 840 houses a plant, such as the plant 2 described above. The plant 2 is held in place in the second portion 840 through the use of a grow medium 7. The grow medium 7 is tightly packed within the second portion 840 and is disposed such that it abuts the material 5 described above that is housed in the first portion 830. The grow medium 7 maintains the position of the plant 2 within the second portion 840 and helps the plant to obtain and utilize nutrients. As illustrated, the second portion 840 is completely filled with a grow medium 7; however, the second portion 840 may be partially filled, as well, depending on the needs of the plant 2. A skilled artisan will be able to select a suitable grow medium based on various considerations, including the size and shape of the plant that will be inserted into the inner member and the liquid into which a buoyant device will be placed. In a particular embodiment, the grow medium may be comprised of any material, including one or more of coconut coir, cotton, jute, hemp, and a proprietary substrate that mimics soil. Additionally, the second portion may also contain no grow medium. Furthermore, in another embodiment, the second portion contains a grow medium, but also includes a thin layer of material upon which the grow medium rests at the distal portion of the second portion. This thin layer of material provides additional support to the grow medium and plant.

The third portion 850 has a proximal end 852, a distal end 853, a side 854 extending from the proximal end 852 to the distal end 853, an outer surface 855, and an inner surface 856. The proximal end 852 and the distal end 853 are substantially parallel to one another and, respectively, define fourth and fifth radii r₄, r₅. The fourth radius r₄ is equal to the fifth radius r₅ in the illustrated embodiment; each of the fourth and fifth radii r₄, r₅ are also equal to the third radius r₃ of the second portion 840, as well. In addition, the side 854 defines a sixth radius r₆ that is greater than the fourth and fifth radii r₄, r₅. However, the proximal end, distal end, and side 852, 853, 854 may have any suitable fourth, fifth, and sixth radii r₄, r₅, r₆. A skilled artisan will be able to select suitable fourth, fifth, and sixth radii in a particular example based on various considerations, including the size and shape the plant that will be inserted into the inner member and the liquid into which a buoyant device that includes the inner member will be placed. In other embodiments, the fourth, fifth, and sixth radii may all be equal. In other embodiments, the sixth radius may be less than the fourth and fifth radii.

The third portion 850 also includes first and second apertures 858, 859. The first and second apertures 858, 859 are each cooperatively defined by the inner and outer surfaces 856, 855. The first and second apertures 858, 859 are substantially cylindrical in shape and have circular openings on the inner and outer surface 856, 855. The apertures 858, 859 allow for a liquid to flow into and out of the third portion 850, enabling the liquid in which a buoyant device is disposed to contact the roots 4 of the plant 2. This allows for the roots 4 of the plant 2 to absorb excess ammonia that is disposed in the liquid, which the plant 2 converts to environmentally preferable nitrate. The first and second apertures 858, 859, therefore, will comprise a radius that allows for a desirable amount of liquid to travel into the third portion 850 to allow for this conversion process. A skilled artisan will be able to determine how many apertures to include and how best to size and shape the apertures in a particular example based on various considerations, including the liquid into which the buoyant device is placed and the size and shape of the plant and its roots disposed in the inner member. In a particular embodiment, the third portion may define one, three, four, five, or more than five apertures. Additionally, the apertures may have openings that are triangular, rectangular, square, or any other shape, and may taper or widen from the outer surface to the inner surface.

The fourth portion 860 has a proximal end 862, a distal end 863, a side 864 extending from the proximal end 862 to the distal end 863, an outer surface 865, and an inner surface 866. The distal end 863 of the fourth portion 860 is also attached to an air compressor 895 that is similar to air compressors 195, 295, described above. The proximal end 862 and the distal end 863 are substantially parallel to one another and, respectively, define seventh and eighth radii r₇, r₈. The seventh radius r₇ is less than the eighth radius r₈ in the illustrated embodiment; the seventh radius r₇ is equal to the fifth radius r₅ of the third portion 850, however. In addition, the side 864 defines a ninth radius r₉ that is greater than the seventh and eighth radii r₇, r₈. However, the proximal end, distal end, and side 862, 863, 864 may have any suitable seventh, eight, and ninth radii r₇, r₈, r₉. A skilled artisan will be able to select suitable seventh, eight, and ninth radii in a particular example based on various considerations, including the size and shape the plant that will be inserted into the inner member and the liquid into which a buoyant device that includes the inner member will be placed. In other embodiments, the seventh, eighth, and ninth radii may all be equal. In other embodiments, the ninth radius may be less than the seventh and eighth radii. In other embodiments, the fourth portion is not attached to an air compressor.

The fourth portion 860 also includes third and fourth apertures 868, 869. The third and fourth apertures 868, 869 are each cooperatively defined by the inner and outer surfaces 866, 865. The third and fourth apertures 868, 869 are substantially cylindrical in shape and have circular openings on the inner and outer surface 866, 865. The apertures 868, 869 allow for a liquid to flow into and out of the fourth portion 860, enabling the liquid in which a buoyant device is disposed to contact the roots 4 of the plant 2. The liquid is propelled up to the roots 4 of the plant 2 that are disposed in the third portion 850. This allows for the roots 4 of the plant 2 to absorb excess ammonia that is disposed in the liquid, which the plant 2 converts to environmentally preferable nitrate. The third and fourth apertures 868, 869, therefore, will comprise a radius that allows for a desirable amount of liquid to travel into the fourth portion 860 to allow for this conversion process. A skilled artisan will be able to determine how many apertures to include and how best to size and shape the apertures in a particular example based on various considerations, including the liquid into which the buoyant device is placed and the size and shape of the plant and its roots disposed in the inner member. In a particular embodiment, the fourth portion may define one, three, four, five, or more than five apertures. Additionally, the apertures may have openings that are triangular, rectangular, square, or any other shape, and may taper or widen from the outer surface to the inner surface.

The fourth portion 860 also contains a plurality of pellets 870. These pellets 870 flow freely throughout the fourth portion 860 and help the plant 2 convert ammonia found in the liquid in which the buoyant device is disposed into nitrate. Each pellet of the plurality of pellets 870 is spherical and provides a large surface area for ammonia to bond to and, when it moves throughout the fourth portion 860, allows for the ammonia to be transported to the third portion 850 through the first passageway 890. Each pellet of the plurality of pellets 870 is too large to escape through the third and fourth apertures 868, 869. Additionally, the air compressor 895 helps to move the plurality of pellets 870 throughout the fourth portion 860 and introduces a greater amount of oxygen to the fourth portion 860 than otherwise would be introduced. A skilled artisan will be able to select a suitable number of pellets to include in a particular example based on various considerations, including the liquid into which the buoyant device is placed and the size and shape of the plant and its roots disposed in the inner member. In a particular embodiment, the plurality of pellets will provide a surface area sufficient to house nitrobacters. In such an embodiment, the plurality of pellets may be comprised of plastic, perlite, and other semi-buoyant materials. In a different embodiment, the pellets may be plastic or metallic, but may be coated with a layer of, for example, plastic, perlite, and other semi-buoyant materials. Each of the plurality of pellets may have any shape and size, as well. Alternatively, the fourth portion may contain no pellets.

FIG. 18A illustrates another example inner member 820′. The inner member 820′ is similar to the inner member 820 described above, except as described below.

The first portion 830′ has a proximal end 832′, a distal end 833′, and a curved lip 834′ extending from the proximal end 832′ to the distal end 833′. Optionally, the first portion 830′ may be fully or partially filled with a material, such as the material 5 described above, that helps a plant (described below) housed in the inner member 820′ fully utilize its surroundings and grow to its greatest capability. A skilled artisan will be able to select a suitable material to place in the first portion based on various considerations, including the size and shape of the plant that will be inserted into the inner member and the liquid into which a buoyant device will be placed. In a particular embodiment, the material can be comprised of any material, including one or more of Rockwool, cotton, jute, hemp, and a proprietary substrate that mimics soil. Additionally, the first portion may contain no material in other embodiments.

The second portion 840′ has a proximal end 842′, a distal end 843′, a side 844′ extending from the proximal end 842′ to the distal end 843′, and an outer surface 845′. In the illustrated embodiment, the second portion 840′ and first portion 830′ are connected such that the first and second portions 830′, 840′ are not separately moveable. The outer surface 845′ of the second portion 840′ defines a first threaded portion 846′. The first threaded portion 846′ is configured to mate with an outer member (not illustrated in the Figures), such as one of the outer members 50, 150, 250, 450 described above. A skilled artisan will be able to select how best to configure the outer surface based on various considerations, including the size and shape of the first and third portions and the outer member to which the inner member will be attached. The first threaded portion may comprise an inner thread or an outer thread. In another embodiment, the first and second portions may be separate components that are separately moveable. Alternative embodiments exist in which the first threaded portion is replaced with an adhesive or a snap-fit structure.

The second portion 840′ houses a plant, such as the plant 2 described above. The plant 2 is held in place in the second portion 840′ through the use of a grow medium, such as the grow medium 7 described above. The grow medium 7 is tightly packed within the second portion 840′ and is disposed such that it abuts the material 5 described above and allows for the roots 4 of the plant 2 to extend into the third portion 850′ of the inner member 820′. The grow medium 7 maintains the position of the plant 2 within the second portion 840′ and helps the plant to obtain and utilize nutrients. As illustrated, the second portion 840′ is completely filled with a grow medium 7; however, the second portion 840′ may be partially filled, as well, depending on the needs of the plant 2. A skilled artisan will be able to select a suitable grow medium based on various considerations, including the size and shape of the plant that will be inserted into the inner member and the liquid into which a buoyant device will be placed. In a particular embodiment, the grow medium may be comprised of any material, including one or more of Rockwool, cotton, jute, hemp, and a proprietary substrate that mimics soil. Alternatively, the second portion may also contain no grow medium. Furthermore, in another embodiment, the second portion contains a grow medium, but also includes a thin layer of material upon which the grow medium rests at the distal portion of the second portion. This thin layer of material provides additional support to the grow medium and plant.

The third portion 850′ has a proximal end 852′, a distal end 853′, a side 854′ extending from the proximal end 852′ to the distal end 853′, an outer surface 855′, and an inner surface 856′. The third portion 850′ also includes first and second apertures 858′, 859′. The first and second apertures 858′, 859′ are each cooperatively defined by the inner and outer surfaces 856′, 855′. The first and second apertures 858′, 859′ are substantially cylindrical in shape and have circular openings on the inner and outer surface 856′, 855′. The apertures 858′, 859′ allow for a liquid to flow into and out of the third portion 850′, enabling the liquid in which a buoyant device is disposed to contact the roots 4 of the plant 2. This allows for the roots 4 of the plant 2 to absorb excess ammonia that is disposed in the liquid, which the plant 2 converts to environmentally preferable nitrate. The first and second apertures 858′, 859′, therefore, will comprise a radius that allows for a desirable amount of liquid to travel into the third portion 850′ to allow for this conversion process. A skilled artisan will be able to determine how many apertures to include and how best to size and shape the apertures in a particular example based on various considerations, including the liquid into which the buoyant device is placed and the size and shape of the plant and its roots disposed in the inner member. In a particular embodiment, the third portion may define one, three, four, five, or more than five apertures. Additionally, the apertures may have openings that are triangular, rectangular, square, or any other shape, and may taper or widen from the outer surface to the inner surface.

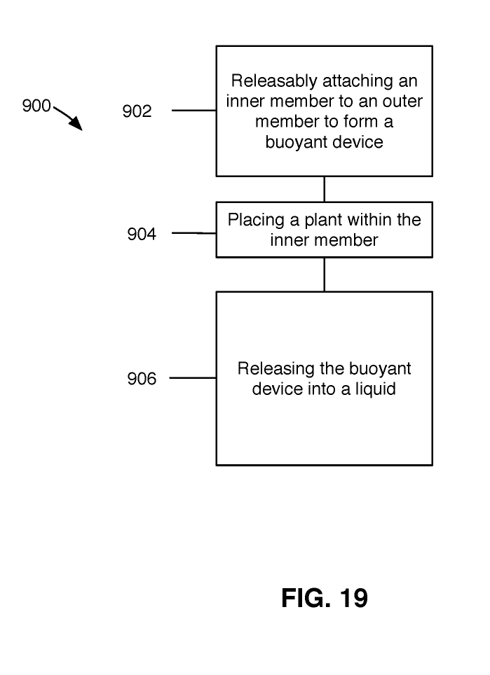

FIG. 19 is a flowchart representation of an example method 900 of placing a buoyant device containing a plant in a liquid. Performance of the method results in the release of a buoyant device into a liquid. An example method includes the use of an inner member, an outer member, and a plant. In other examples, a single member may be used instead of an outer member and an inner member and a buoyant system may be used instead of a single buoyant device. Furthermore, soil or any other organic material, foam impregnated with soil, a mechanical filtration device, or any other item or device may be used in place of a plant.

An initial step 902 comprises releasably attaching an inner member to an outer member to form a buoyant device. Inner member 20 and outer member 50 are described in this step. Inner member 20 is releasably attached to outer member 50 to form buoyant device 10. The inner member may comprise any of the inner members 120, 220, 420 described above. The outer member may comprise any of the outer members 150, 250, 450 described above. Any suitable inner member and any suitable outer member may be used to perform this step.

Another step 904 comprises placing a plant within the inner member such that the plant is at least partially disposed within the liquid. Plant 2 is described in this step. The plant may comprise any plant, however, and may also comprise soil or any other organic material, foam impregnated with soil, a mechanical filtration device, or any other item or device.

Another step 906 comprises releasing the buoyant device into the liquid. The liquid may comprise any body of water, including as an ocean, creek, river, or lake.

It is noted that it is considered advantageous to complete the method 900 in the order illustrated and described. However, any order is considered suitable.

All components of the buoyant device can be made from any suitable material. Non-limiting examples of suitable materials include plastic, polystyrene, or any other suitable material. Non-limiting examples of materials considered specifically suitable for use in the inner member and outer members include any type of plastic or metal.

Those with ordinary skill in the art will appreciate that various modifications and alternatives for the described and illustrated embodiments can be developed in light of the overall teachings of the disclosure. Accordingly, the particular arrangements disclosed are intended to be illustrative only and not limiting as to the scope of the invention, which is to be given the full breadth of the appended claims and any and all equivalents thereof

We claim:

1. A buoyant device configured to house a plant, comprising:
an outer member having an upper surface, a lower surface, a side disposed between the upper surface and the lower surface, and a first passageway extending from the upper surface to the lower surface, the first passageway defining a first inner surface; and
an inner member having an upper surface, a lower surface, a side extending from the upper surface to the lower surface, and a second passageway extending from the upper surface to the lower surface, the second passageway defining a second inner surface, the second inner surface configured to house said plant;
wherein the side of the inner member is releasably attached to the first inner surface.

2. The buoyant device configured to house a plant of claim 1, wherein the first inner surface comprises a first threaded portion.

3. The buoyant device configured to house a plant of claim 2, wherein the side of the inner member comprises a second threaded portion configured to mate with the first threaded portion.

4. The buoyant device configured to house a plant of claim 3, wherein the second inner surface comprises a plurality of teeth.

5. The buoyant device configured to house a plant of claim 1, further comprising a solar panel disposed on the upper surface of the outer member.

6. The buoyant device configured to house a plant of claim 5, further comprising a light source disposed on the upper surface of the outer member.

7. The buoyant device configured to house a plant of claim 6, wherein the solar panel is operably connected to the light source; and
wherein the solar panel provides power to the light source.

8. The buoyant device configured to house a plant of claim 7, further comprising an air compressor disposed on the lower surface of the outer member.

9. The buoyant device configured to house a plant of claim 8, wherein the air compressor includes a battery.

10. The buoyant device configured to house a plant of claim 1, wherein the outer member defines a channel extending from the upper surface to the lower surface.

11. The buoyant device configured to house a plant of claim 10, further comprising a pile;
wherein the pile has an anchor and a sensor; and
wherein the pile extends through the channel.

12. A buoyant device configured to house a plant, comprising:
an outer member having a first portion, a second portion, a third portion, and a fourth portion, the first portion releasably attached to the second portion and the fourth portion, the second portion releasably attached to the first portion and the third portion, the third portion releasably attached to the second portion and the fourth portion, the first portion, second portion, third portion, and fourth portion cooperatively defining an upper surface, a lower surface, a side extending from the upper surface to the lower surface, and a first passageway, the upper surface being substantially circular, the lower surface being substantially circular, the first passageway extending from the upper surface to the lower surface, the first passageway defining a first inner surface; and
an inner member having an upper surface, a lower surface, a side extending from the upper surface to the lower surface, and a second passageway, the second passageway extending from the upper surface to the lower surface, the second passageway defining a second inner surface, the second inner surface configured to house said plant;
wherein the side of the inner member is releasably attached to the first inner surface.

13. The buoyant device configured to house a plant of claim 12, further comprising a solar panel disposed on the upper surface of the outer member.

14. The buoyant device configured to house a plant of claim 13, further comprising a light source disposed on the upper surface of the outer member.

15. The buoyant device configured to house a plant of claim 14, wherein the solar panel is operably connected to the light source; and
wherein the solar panel provides power to the light source.

16. The buoyant device configured to house a plant of claim 15, further comprising an air compressor disposed on the lower surface of the outer member.

17. The buoyant device configured to house a plant of claim 16, wherein the air compressor includes a battery.

18. A buoyant system configured to house two or more plants, comprising:
a first outer member having an upper surface, a lower surface, a side disposed between the upper surface and the lower surface, and a first passageway, the upper surface being hexagonal in shape, the lower surface being hexagonal in shape, the first passageway extending from the upper surface to the lower surface, the first passageway defining a first inner surface, the first inner surface comprising a first threaded portion;
a first inner member having an upper surface, a lower surface, a side disposed between the upper surface and the lower surface, and a second passageway, the second passageway extending from the upper surface to the lower surface, the second passageway defining a second inner surface, the side comprising a second threaded portion releasably attached to the first threaded portion;
a second outer member having an upper surface, a lower surface, a side disposed between the upper surface and the lower surface, and a third passageway, the upper surface being hexagonal in shape, the lower surface being hexagonal in shape, the third passageway extending from the upper surface to the lower surface, the third passageway defining a third inner surface, the third inner surface comprising a third threaded portion; and
a second inner member having an upper surface, a lower surface, a side disposed between the upper surface and the lower surface, and a fourth passageway, the fourth passageway extending from the upper surface to the lower surface, the fourth passageway defining a fourth inner surface, the side comprising a fourth threaded portion releasably attached to the third threaded portion;
wherein the second inner surface is in contact with one of said two or more plants;
wherein the fourth inner surface is in contact with one of said two or more plants; and
wherein the side of the first outer member is in contact with the side of the second outer member.

19. The buoyant system configured to house two or more plants of claim 18, further comprising a first channel extending from the upper surface of the first outer member to the lower surface of the first outer member; and
a second channel extending from the upper surface of the second outer member to the lower surface of the second outer member.

20. The buoyant system configured to house two or more plants of claim 19, further comprising a connecting member extending through the first channel and the second channel.
